(19) United States
(12) Patent Application Publication
(10) Pub. No.: US 2010/0309550 A1
(43) Pub. Date: Dec. 9, 2010

(54) HEAD-MOUNTABLE LOUPE

(75) Inventors: Christoph Hauger, Aalen (DE); Fritz Strähle, Heubach (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Carl Zeiss Surgical GmbH, Oberkochen (DE)

(21) Appl. No.: 12/796,564

(22) Filed: Jun. 8, 2010

Related U.S. Application Data
(63) Continuation of application No. PCT/EP2007/010750, filed on Dec. 10, 2007.

(51) Int. Cl. G02B 23/02; G02B 23/18

(52) U.S. Cl. 359/481

(57) ABSTRACT

A head-mountable loupe for observing an object includes a support configured to be attachable to the head of a user and optics mounted to the support and including an objective lens, left and right oculars and a plurality of beam folding mirrors. The loupe has an observation configuration in which the left and right oculars are disposed in front of left and right eyes, respectively, of the user, to establish a folded left beam path originating from the object, traversing the objective lens and the left ocular and reflected from plural beam folding mirrors, and to establish a folded right beam path originating from the object, traversing the objective lens and the right ocular and reflected from plural beam folding mirrors.

### CROSS-REFERENCES TO RELATED APPLICATIONS

This application claims priority to and is a continuation of International Patent Application PCT/EP2007/010750, filed Dec. 10, 2007, the contents of which is hereby incorporated by reference in its entirety for all purposes.

### BACKGROUND OF THE INVENTION

The present invention relates to a head-mountable loupe for observing an object. Such a loupe usually comprises a support (such as a headband) configured to be attached to the head of a user, and optics mounted to the support. With modern head-mountable loupes, the optics usually provides a magnified image of an object, to be observed through separate beam paths, to the left and right eyes of the user.

Such head-mountable loupes are used in dentistry, surgery, precision engineering or jewelry, for making example. They are suitable in any field requiring a magnified view of an object while the user still needs their hands to manipulate the object.

### SUMMARY OF THE INVENTION

The optics of a head-mountable loupe according to the prior art are shown in FIG. 1.

As can be seen from FIG. 1, a left beam path C1′ of the loupe is defined by a left objective lens F1′, a left prism Z1′ and a left ocular M1′. A right beam path Cr′ of the loupe is defined by a right objective lens Fr′, a right prism Zr′ and a right ocular Mr′. The optical elements of the left and right beam paths C1′ and Cr′ are oriented such that central beams of the left and right beam paths C1′ and Cr′ miter in an object plane A′ such that they intersect forming a stereoscopic angle α′. To achieve a stereoscopic effect, the stereoscopic angle α′ should range from 1° to 18° and especially from 6° to 8°. In consequence, an object B′ arranged in the object plane A′ can be observed in a magnified way while a stereoscopic effect is maintained. The stereoscopic effect is desirable if the object is subject to manipulation.

The left and right prisms Z1′, Zr′ each are prisms according to Schmidt-Pechan and thus comprise roof-pentaprisms. The prisms provide a straight view and achieve an image reversal. In FIG. 1, the two prism-components forming each of the two prisms according to Schmidt-Pechan are illustrated as glass blocks for simplification of the Figure.

The left and right objective lenses F1′, Fr′ and the left and right prism Z1′, Zr′ generate left and right intermediate pictures K1′ and Kr′ of the object B′. The left and right intermediate pictures K1′ and Kr′ are looked at through the left and right oculars M1′ and Mr′. As one intermediate picture is used in the left and right beam paths, this loupe, according to the prior art, provides an imaging in two stages. The left and right oculars M1′ and Mr′ are configured such that left and right exit pupils N1′ and Nr′ of the optics are arranged for the left and right eye of a user, respectively. In FIG. 1, a working distance Y of the loupe is 300 mm.

A loupe having the configuration of FIG. 1 works according to the “Greenough”-principle as the optical axis of the optical elements (F1′, Z1′, M1′) of the left beam path and the optical axis of the optical elements (Fr′, Zr′, Mr′) of the right beam path are inclined with respect to one another by the stereoscopic angle α′.

It is a disadvantage of the head-mountable loupe described above that variation of the working distance (focusing) is very complicated, because the inclination of the optical axis of the elements of the left and right beam paths has to be adjusted correspondingly. Furthermore, the loupe has a large size in the direction of the left and right beam path. This results in a large lever arm with respect to the head of a user when the loupe is in an observation configuration in which the left and right oculars are disposed in front of the left and right eyes of the user. In consequence, handling such a loupe is inconvenient.

Another head-mountable loupe that works according to the Greenough-principle is known from prior art document U.S. Pat. No. 3,865,468. However, the magnification achievable with this system is insufficient. Moreover, the beam paths are influenced by reflections caused by scattered light incident from outside the loupe.

A further head-mountable loupe working according to the Greenough-principle, but having increased magnification is known from WO 96/09566. However, the size of the loupe in the direction of the object plane, and thus away from the front of the user's head is still very large. Thus, the lever arm working on the head of a user wearing the loupe is large. The mechanics required to incline the optical axes of the left and right beam paths in dependency to a working distance is very complex. Moreover, the proposed loupe does not allow the user to easily view the object directly, i.e. without using the optics. In the following, this will be referred to as “direct view”.

A head-mountable loupe having a reduced extension in the direction of the beam paths is known from DE 896 127. However, the loupe according to this prior art has only one optical lens. The resulting total magnification of an object to be observed is insufficient. Moreover, an adaptation to varying working distances, as well as a variation of the magnification, is not possible.

A very simple head-mountable loupe that allows a downwardly directed view of a user is known from US 2007/0171520 A1. In this document, it is proposed to use a prism system to fold the left and right beam paths. However, the length of the respective optical paths through the glass of the prism system is very large. This results in a restriction of a field of view and makes the user feel as if he would be looking through a keyhole. Furthermore, the large amount of glass necessary to realizing this prism system significantly increases the weight of the proposed loupe. Finally, the achievable magnification is insufficient.

With loupes working in line with the Greenough-principle, the optical axes of the optical elements forming the left and right beam paths, respectively, are inclined with respect to one another. Therefore, an adaptation to differing working distances is very complicated as the inclination of the optical axes of the optical elements must be adapted correspondingly.

This can be avoided by using a common objective lens that is traversed by both the left and right beam path in an off-axis manner. Off-axis manner means that central beams of the left and right beam paths enter the common objective lens at a distance from the optical axis of the common objective lens. By suitably choosing the optical parameters of the common objective lens (that usually will be a compound lens) it can be guaranteed that the left and right beam path miter in the object plane at a certain working distance forming a stereoscopic angle.

Head-mountable loupes working according to this principle are known from prior art documents DE 101 34 896 A1 and DE 10 2006 001 888 A1. However, the loupes according to these prior art documents are still rather large and therefore not sufficiently convenient for a user. Furthermore, the loupes do not yet provide a direct view for the user in a sufficiently easy and quick way.

Starting from the above prior art documents, it is an object of the present invention to provide a head-mountable loupe that overcomes the problems described above. According to an embodiment, it is an object of the present invention to provide a head-mountable loupe that is convenient to use as it has a moderate weight and a compact size. According to a further embodiment, it is an object of the present invention to provide a head-mountable loupe that provides a direct view for a user in a convenient way.

The above object is solved in a head-mountable loupe comprising the combination of features of the independent claims. Preferred embodiments are described in the dependent claims.

According to an embodiment, a head-mountable loupe for observing an object comprises a support, configured to be attachable to the head of a user, and optics mounted to the support, which include an objective lens, left and right oculars and a plurality of beam folding mirrors. The loupe has an observation configuration in which the left and right oculars are disposed in front of the user's left and right eyes, respectively, to establish a folded left beam path originating from the object, traversing the objective lens and the left ocular and reflected from plural beam folding mirrors, and to establish a folded right beam path originating from the object, traversing the objective lens and the right ocular and reflected from plural beam folding mirrors. Furthermore, in the observation configuration of the loupe, surface normals of first beam folding mirrors are oriented relative to a mathematical plane which coincides with optical axes of the left and right oculars under an angle within a range from 20° to 65°, and portions of the left and right beam paths between the object and the first beam folding mirrors are each free of further beam folding mirrors.

The above configuration guarantees that the beam paths incident from the object plane to the loupe are firstly deflected in a direction that is oriented up or down with respect to the forehead of a user when the loupe is used. This kind of folding the incident beam paths allows a compact construction of the loupe, as the optics of the loupe may be arranged in more than one plane (with respect to the plane defined by the eyes of the user and the object) and especially in two or more parallel planes.

In the present application, the optics may be mounted either detachably or permanently to the support. A quick-release fastener might be provided to mount the optics to the support e.g. to allow separate storage of the optics and the support and/or adaptation of a position where the optics is mounted to the support.

The optics may comprise all kind of optical elements such as lenses, compound lenses, mirrors, prisms and optical elements having variable refraction (e.g. liquid lenses). Furthermore, the optics may even comprise elements for varying distances between lenses (such as motors or actuators) or for illuminating the object plane (such as lamps or lasers). The beam folding mirrors might be realized by reflecting surfaces of mirrors or prisms or both. Even semi-transparent mirrors might be used where appropriate.

For achieving the desirable effects of the invention, it is not necessary that the loupe has other configurations than the above observation configuration in which the left and right oculars are disposed in front of left and right eyes, respectively, of the user. Between the oculars and the eyes of the user there might be ophthalmic glasses of the user that are not part of the optics of the loupe.

To achieve a stereoscopic effect, the optics may be configured such that central beams of the folded beam paths intersect in the object plane forming a stereoscopic angle.

In the present application, a surface normal to a flat surface (such as a mirror) is a vector that is perpendicular to that surface. Moreover, a mathematical plane is not a physically existent plane but an imaginary geometric plane in three-dimensional space. As usual in trigonometry, an angle is the figure formed by two rays sharing a common endpoint. The angle between a straight line and a plane is the angle between the straight line and an orthogonal projection of the straight line on the plane.

Although it is preferred that the angle between the surface normals of first beam folding mirrors and the mathematical plane defined by the optical axes of the left and right oculars is within a range from 20° to 65°, according to an alternative embodiment the angle may be within a range from 20° to 50° or 40° to 65°. According to a further alternative embodiment the angle may be within a range from 25° to 45° and especially from 30° to 40° or within a range from 45° to 65° and especially from 50° to 60°.

If an incoming beam path is folded upwards by the first beam folding mirrors and the angle is below 45°, the user may retain a straight position of his head while examining an object disposed in an object plane that is located below the mathematical plane, e.g. at the height of the user's stomach and thus a convenient working position for the hands of the user. This straight position of the head reduces strain and cramping of the user's neck muscle and thus is very convenient.

According to an embodiment, the objective lens comprises at least one first objective lens element disposed in the portions of the left and right beam paths, disposed between the object and the first beam folding mirrors. Thus, beam paths incident from the object plane first pass the first objective lens before being folded by the first beam folding mirror. The objective lens may prevent dust from entering the optics. Alternatively, a separate cover glass might be provided. Moreover, an objective lens located at this position may be exchanged with ease e.g. for adapting the loupe to different working distances.

According to a further embodiment, the at least one first objective lens element is a single lens element traversed by both the left and right beam paths. If two separate first objective lenses are used for the left and right beam paths (as it is the case in typical Greenough-systems), a precise alignment of these lenses is require to guarantee that both left and right beam paths miter in the object plane forming a stereoscopic angle. This alignment is avoided if one common lens element is used for both stereoscopic beam paths. In this respect the term “single lens element” does not exclude usage of compound lenses or lenses having variable refraction power.

According to a further embodiment, the objective lens comprises at least a second objective lens element disposed in the portions of the left and right beam paths between the first beam folding mirrors and the left and right oculars, respectively. In this respect, the at least one second objective lens element may be a single lens element traversed by both the left and right beam paths, for example. By this construction it can be guaranteed that both left and right beam paths miter in the object plane forming a stereoscopic angle, even if the working distance is altered (provided that the shapes of the first and second objective elements (e.g. lenses) are suitably chosen). Alternatively, separate second objective elements might be provided for each of the left and right beam paths.

According to a further embodiment, a head-mountable loupe for observing an object is provided, the loupe comprising a support configured to be attachable to the head of a user and optics mounted to the support and including an objective lens, left and right oculars and a plurality of beam folding mirrors. The loupe has an observation configuration in which the left and right oculars are disposed in front of the user's left and right eyes, respectively, to establish a folded left beam path originating from the object, traversing the objective lens and the left ocular and reflected from plural beam folding mirrors, and to establish a folded right beam path originating from the object, traversing the objective lens and the right ocular and reflected from plural beam folding mirrors. Further, in the observation configuration of the loupe, the objective lens comprises at least one first objective lens element having an optical axis oriented relative to a mathematical plane that coincides with optical axes of the left and right oculars under an angle of more than 70°. According to an embodiment, this angle may be more than 80° and especially equal to 90°.

Thus, the objective lens may be arranged in a horizontal position in parallel to a front of a user's head. In this respect, “horizontal” is not to be interpreted in a literal technical sense but in a sense of laying in a leftward and rightward direction. The left and right beam paths traversing the objective lens are oriented upwardly or downwardly with respect to the forehead of a user when the loupe is used (in observation configuration). This allows a compact construction of the loupe as the optics of the loupe may be arranged in more than one plane (with respect to the plane defined by the eyes of the user and the object). Moreover, the objective lens that has a significant size, and thus weight, can be located very close to the forehead of a user. Thus, the lever arm of this lens is especially short. It has to be borne in mind that the glass material of the lenses causes a significant amount of the weight of the loupe.

As usual in optics, the term optical axis is used in the present application to define a direction along which there is some degree of rotational symmetry. Thus, with respect to an optical lens the optical axis is the direction along which the optical surfaces of the lens have rotational symmetry. Thus, the optical axis passes through the center of curvature of each surface.

In this respect, according to an embodiment, the angle of surface normals of the first beam folding mirrors, relative to the mathematical plane coinciding with the optical axes of the left and right oculars in the observation configuration of the loupe, is changeable by tilting the first beam folding mirrors.

As the first beam folding mirrors are the first mirrors of the loupe traversed by a beam path originating from an object to be observed, a line of sight (viewing direction) of a user of the head-mountable loupe can be altered by tilting the first beam folding mirrors while the user can maintain a constant position of his head.

The first beam folding mirrors might be tilted, either in one single direction or in two directions that may be perpendicular to one another. In an embodiment in which the first beam folding mirrors can be tilted in only one single direction, the rotation axis of the first beam folding mirrors coincides with the straight line interconnecting the central beams of the two beam paths originating from the object to be observed at points where the two beam paths meet the first beam folding mirrors. Alternatively, the rotation axis may even be parallel to said straight line. According to an embodiment, an actuator such as a motor is provided for dynamically tilting the first beam folding mirrors in dependency on a control signal input by the user during operation of the loupe. According to an alternative embodiment, the tilt of the first beam folding mirrors is adjusted manually, e.g. by using screws.

According to an embodiment, the at least one first beam folding mirrors are provided by a mirror common for the left and right beam paths having a contiguous mirror surface. Thus, both the left and right beam paths simultaneously use the mirror surface. This facilitates the structure of the loupe, as no alignment of separate mirror surfaces of the first beam-folding mirrors is necessary. Alternatively, the first beam-folding mirrors may be provided with separated mirror surfaces for the left and right beam paths. This may have the advantage that e.g. an illuminating beam path for illuminating the object in the object plane could be provided between the mirror surfaces for the left and right beam paths.

According to an embodiment, the head-mountable loupe further comprises second beam folding mirrors having surface normals oriented relative to the surface normals of the first beam folding mirrors under angles within a range from 60° to 110° and especially 60° to 95°. Thus, beam paths incident from the object plane to the loupe firstly are deflected by the first beam folding mirrors in a direction that is oriented up or down, and secondly in a direction back and forth with respect to the forehead of a user when the loupe is used.

Further in this respect, according to an embodiment a common mirror for the left and right beam paths and having a contiguous mirror surface may provide the second beam folding mirrors. In this case, both the left and right beam paths simultaneously use the mirror surface.

This facilitates the structure of the loupe, as no alignment of separate mirror surfaces is necessary. Alternatively, separated mirror surfaces may be provided for the left and right beam paths to realize the second beam folding mirrors.

According to an embodiment, portions of the left and right beam paths between the first and second beam folding mirrors are each free of further beam folding mirrors. Further, the objective lens comprises at least one objective lens element disposed in the portions of the left and right beam paths between the first and second beam folding mirrors. Thus, the objective lens may be arranged above the first beam folding mirrors, whereas the second beam folding mirrors are arranged above the at least one objective lens when the loupe is attached to the forehead of a user. This arrangement makes the loupe more compact as the objective lens can be arranged in an intermediate plane between the first and second beam folding mirrors. Moreover, by this arrangement the objective lens may be arranged especially close to the forehead of a user when the loupe is attached to the head of the user. This reduces the torsion arm of the objective lens with respect to the head of the user, thus increasing the user's comfort.

According to a further embodiment, a head-mountable loupe for observing an object comprises a support configured to be attachable to the head of a user, and a chassis mounted to the support for holding optics, the optics including an objective lens, left and right oculars and a plurality of beam folding mirrors. The loupe has an observation configuration in which the left and right oculars are disposed in front of left and right eyes, respectively, of the user, to establish a folded left beam path originating from the object, traversing the objective lens and the left ocular and reflected from plural beam folding mirrors, and to establish a folded right beam path originating from the object, traversing the objective lens and the right ocular and reflected from plural beam folding mirrors. Moreover, according to this embodiment the loupe has a direct-view configuration in which the oculars are not disposed in front of the left and right eyes, respectively, of the user. The chassis comprises a main body, and left and right chassis portions articulated to the main body. The left and right oculars are mounted to the left and right chassis portions, respectively. To provide the observation configuration and the direct-view configuration, left and right chassis portions are pivotable about left and right pivoting axes, wherein a distance between the left and right pivoting axes is within a range from 35 mm to 75 mm. According to an embodiment, this distance ranges from 40 mm to 75 mm. Furthermore, distances between the left pivoting axis and an optical axis of the left ocular and between the right pivoting axis and an optical axis of the right ocular are greater than 20 mm. According to an embodiment, these distances are greater than 30 mm. Such a direct view is desirable to allow a more global orientation of the user.

Due to this configuration a user may have a direct view to the object plane by simply flipping the oculars up while an orientation of the optical axes of the oculars remains unchanged. The above distances between the two pivoting axes, and between the oculars and the respective pivoting axes, guarantee that the oculars can be moved very quickly away from the field of view of a user and do not disturb the direct view of the user once they are moved away.

According to a further embodiment, the head-mountable loupe may further comprise at least one movable lens disposed in the left beam path and displaceable in a direction thereof, and at least one movable lens disposed in the right beam path and displaceable in a direction thereof, for changing a magnification of the loupe. Thus, the movable lenses are provided separately for the left and right beam paths. In consequence, zoom functionality may be provided.

According to a further embodiment, the objective lens comprises at least one first objective lens element and at least one second objective lens element displaceable relative to the at least one first objective lens element for changing focal length (and thus angle of view) of the loupe to account for a change of a distance of an object plane of the loupe from the left and right oculars. This allows an adaptation of the loupe to varying working distances. The displaceable second objective lens elements may be provided either commonly or separately for the left and right beam paths. In this respect, “commonly” means that both the left and right beam paths traverse the lens, whereas “separately” means that only one of the left and right beam paths traverses the lens.

According to a further embodiment, the objective lens comprises at least one first removable objective lens element mounted on a frame structure comprising a handle portion exposed at a loupe body and allowing the user to grasp the frame structure to remove it from the loupe. Thus, the objective lens may be removed with ease from the loupe and may be exchanged by another removable objective lens having a different refraction coefficient to adapt the loupe to different working distances. With respect to the handle, the term “exposed” means that the handle is graspable by a user from outside the loupe body. This might require usage of a certain tool or even removing of a separate cover from the loupe body. However, it must be possible for the user to grasp and remove the objective lens element separately from the other optics of the loupe.

According to an embodiment, the support may be a headband system. Alternatively, the support may be an eyeglass frame, for example. Such supports are well known to users of head-mountable loupes. The support might even have a counterbalance at the back of the head of the user for balancing the weight of the loupe, for example.

### BRIEF DESCRIPTION OF THE DRAWINGS

In the following, preferred embodiments of the present invention are described in more detail by reference to the enclosed drawings, in which similar or same elements are denoted by similar or the same reference signs. In the drawings,

FIG. 1 is a schematic top view of the optics of a head-mountable loupe working according to the Greenough principle as per the prior art;

FIGS. 2A-2C are schematic side views of the optics of a head-mountable loupe according to a first embodiment of the present invention in different operating states, wherein the optics are unfolded in one plane;

FIG. 2D is a perspective side views of a head-mountable loupe of the first embodiment;

FIGS. 2E-2F are perspective views of a head-mountable loupe according to the first embodiment;

FIGS. 3A-3B are schematic side views of the optics of a head-mountable loupe according to a second embodiment of the present invention, in different operating states;

FIG. 4 is a schematic side view of the optics of a head-mountable loupe according to a third embodiment of the present invention;

FIGS. 5A-5B are schematic side views of the optics of a head-mountable loupe according to a fourth embodiment of the present invention, in different operating states;

FIGS. 6A-6C are schematic side views of the optics of a head-mountable loupe according to a fifth embodiment of the present invention, in different operating states;

FIG. 7A is a perspective view of a chassis of a head-mountable loupe according to an embodiment of the present invention;

FIG. 7B is a perspective view of a support of a head-mountable loupe according to an embodiment of the present invention;

FIG. 7C is a perspective view showing the chassis mounted to the support;

FIG. 8A is a perspective view of an alternative chassis and support of a head-mountable loupe according to the present invention;

FIG. 8B is a side view of the alternative chassis illustrated in FIG. 8A; and

FIG. 9 is a schematic top view on a first removable objective lens element mounted on a frame structure comprising a handle according to an embodiment of the present invention.

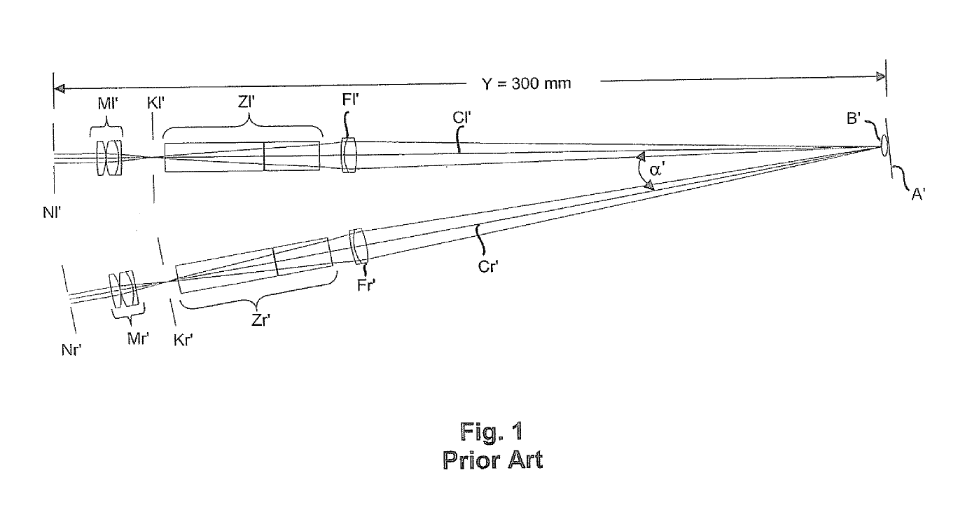

### DETAILED DESCRIPTION OF SPECIFIC EMBODIMENTS

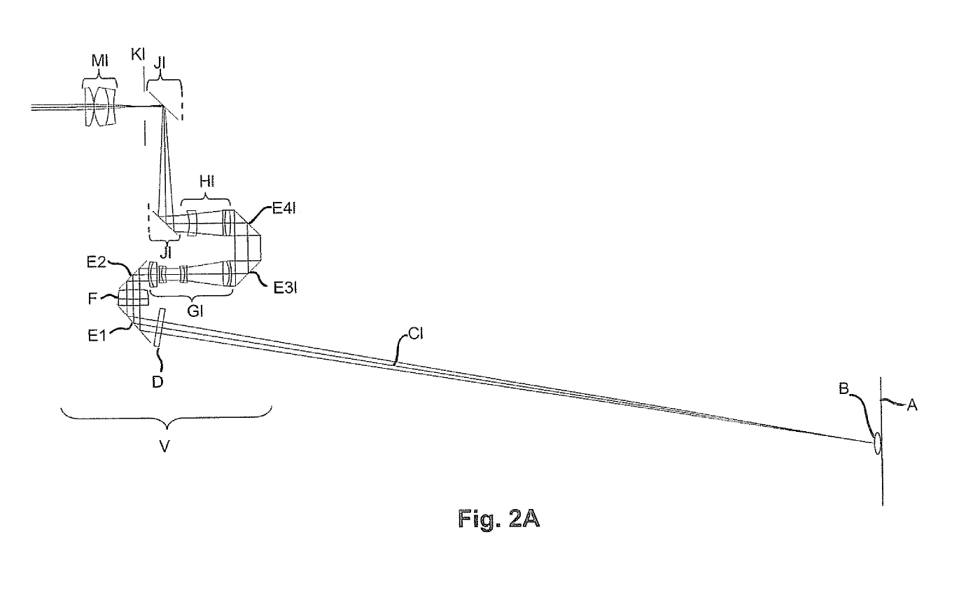

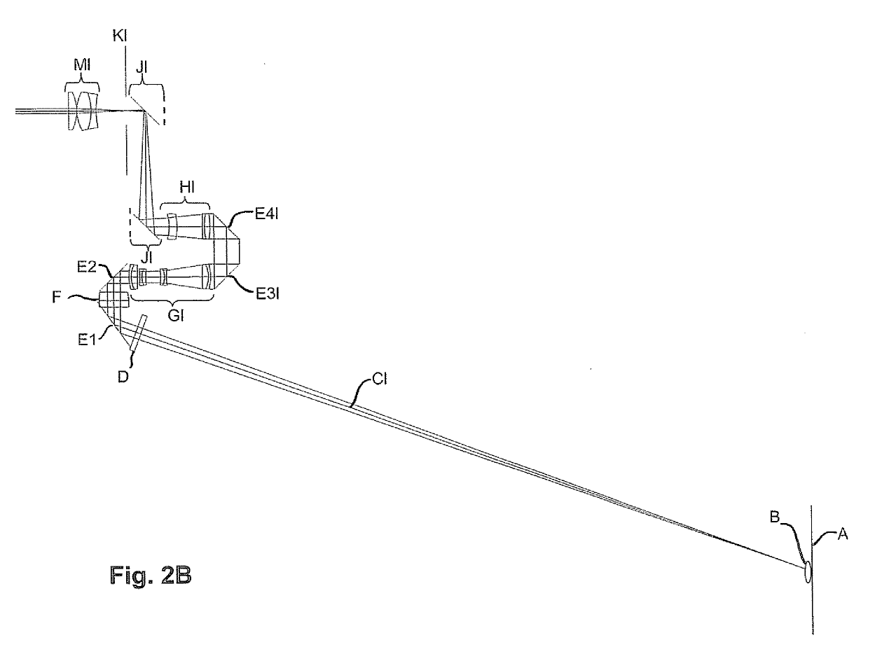

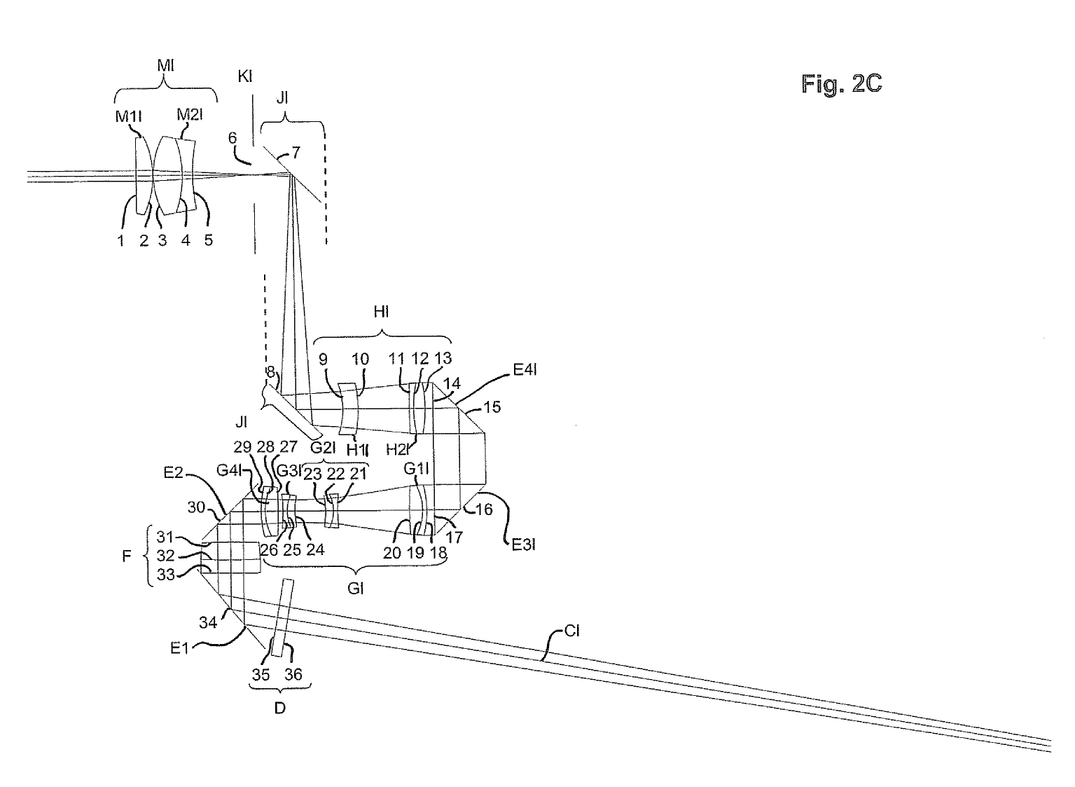

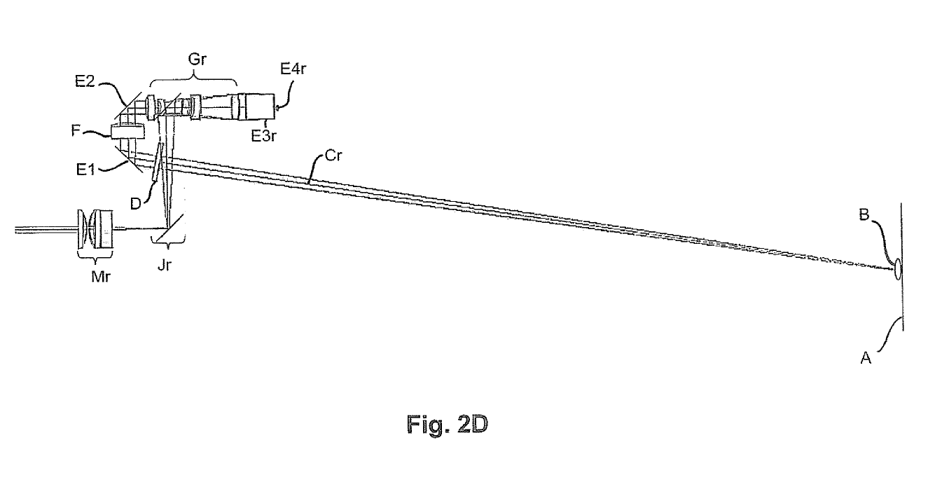

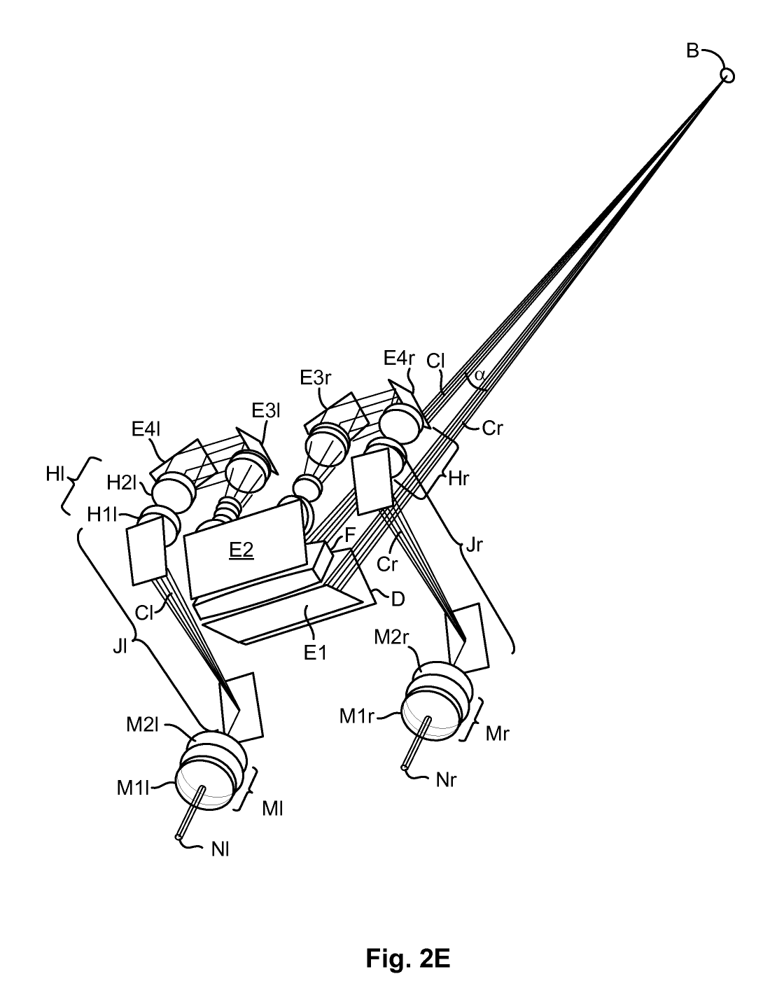

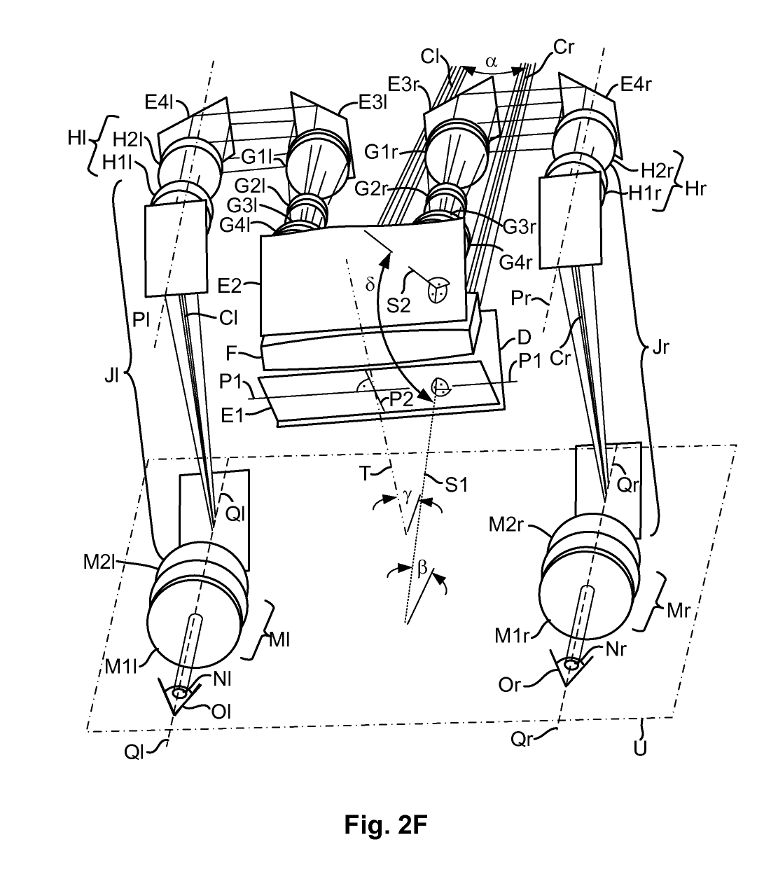

In the following, a first embodiment of a head-mountable loupe according to the present invention will be described in detail by referring to FIGS. 2A to 2F.

FIGS. 2A to 2C show schematic side views of the optics V of the loupe in different operating states, wherein the optics is enfolded in one plane and only the optical elements of the optics traversed by the left beam path C1 are shown. FIG. 2D is a perspective side view of the optics, showing only optical elements traversed by the right beam path Cr. FIGS. 2E and 2F are perspective views of the optics showing both beam paths C1 and Cr.

Referring to FIGS. 2E and 2F, the optics of the head-mountable loupe for observing an object B provide left and right beam paths C1, Cr. Central beams of the two beam paths C1, Cr miter and thus intersect at the object B forming a stereoscopic angle α, provided the object B is arranged in an object plane A of the loupe.

The optics comprise a cover glass D, a first beam folding mirror E1, an objective lens F and a second beam folding mirror E2 that are consecutively traversed by both the left and right beam paths C1, Cr. Thus, both the left and right beam paths C1, Cr commonly use the cover glass D, the first and second beam folding mirrors E1 and E2 and the objective lens F. There is only one single objective lens element F for both left and right beam path C1, Cr. This objective lens element F is a compound lens having more than two optical surfaces. Each of the first and second beam folding mirrors E1 and E2 has a continuous mirror surface for the left and right beam paths C1, Cr.

In the present embodiment, the cover glass D has no refractive power at all and simply serves to prevent dust and dirt from entering the optics. However, the cover glass D may also serve as a filter and/or have a low refractive power of preferably less than 0.1 dpt.

After having traversed the second beam folding mirror E2, the left beam path C1 is separately guided to optical lenses G11 to G41 of a left magnification-changer and folded by left third and fourth beam folding mirrors E31, E41. Afterwards, the left beam path C1 is guided to a left optical tube H1 and consecutively enters left optical offset-generators J1, before traversing left ocular M1. Thus, the left and right magnification-changers G1, Gr are arranged in the beam path between the second and third beam folding mirrors E2, E31, E3r, respectively.

Similar, the right beam path Cr is separately guided to optical lenses G1r to G4r of a right magnification-changer and folded by right third and fourth beam folding mirrors E3r, E4r, after having traversed the second beam folding mirror E2. Afterwards, the right beam path Cr is guided to a right optical tube Hr and consecutively enters right optical offset-generators Jr, before traversing right ocular Mr.

The left and right magnification-changers G1, Gr are optical zooms each consisting of four optical compound lenses G11, G21, G31 and G41 respectively G1r, G2r, G3r and G4r. By moving the two middle lenses G21, G31 and G2r, G3r along the respective left and right beam paths C1, Cr the magnification of the loupe can be changed. Actuators, not shown in the figures, can be used to move the lenses. Suitable actuators are well known in the art of optics and might be manually operated mechanics or step motors, for example.

The left third and fourth beam folding mirrors E31, E41 are realized by reflecting surfaces 16, 15 of an optical prism and the right third and fourth beam folding mirrors E3r, E4r are realized by reflecting surfaces 16, 15 of another optical prism. As shown in FIG. 2C, the optical prisms further have entrance surfaces 17 and exit surfaces 14. However, reflecting surfaces of ordinary mirrors alternatively could be used as the third and fourth beam folding mirrors.

The left and right optical tubes H1, Hr are mainly responsible for generating left and right intermediate pictures K1, Kr. In the present case, the tubes H1, Hr each consist of one optical compound lens H21, H2r and one additional optical lens H11, H1r. Usage of the additional optical lenses H11, H1r in each optical tube H1, Hr increases picture quality of the respective intermediate pictures K1, Kr. However, usage of these additional lenses H11, H1r is only optional, as the left and right intermediate pictures K1, Kr can already be provided by using only the compound lenses H21, H2r.

The left and right intermediate pictures K1, Kr thus are located between the respective left and right fourth beam folding mirrors E41, E4r and the corresponding ocular M1, Mr.

The left and right offset-generators J1, Jr each are left and right rhomboid-mirrors. The function of the offset-generators will be described later in more detail.

The left and right oculars M1, Mr each consist of two ocular lenses M11, M21 and M1r, M2r. Left and right exit pupils N1, Nr of the optics are located in the pupil of the left and right eyes O1, Or of a user, when the left and right oculars M1, Mr are disposed in front of the user's eyes O1, Or. A distance between exit pupils N1, Nr and the first ocular lens M11, M1r of the left and right oculars is 21 mm. The situation when the left and right oculars M1, Mr are disposed in front of the left and right eyes O1, Or of a user is termed “observation configuration” of the head-mountable loupe. The “observation configuration” is different from the “direct view” where the user does not use the optics.

As it is shown in FIG. 2F, optical axes Q1 and Qr of the left and right oculars M1, Mr define a mathematical plane U by coinciding with this plane U. The first beam folding mirror E1 is oriented such that surface normals S1 of the first beam folding mirror E1 include an angle β with the mathematical plane U. The tilt of the first beam folding mirror E1 is adjustable to vary this angle β within a range from 20° to 50°. This becomes more apparent by comparison of FIGS. 2A and 2B. In the operating stage shown in FIG. 2A, the angle β between the surface normal S1 of the first beam folding mirror E1 and the plane U is 40° whereas in the operating stage shown in FIG. 2B the angle β is 35°. However, the present invention is not limited to these values. It is generally sufficient if the angle β is within a range from 20° to 65°.

In the present embodiment, the inclination of the first beam folding mirror E1, and thus the angle β, is altered by manually operating screws of a frame holding the mirror (the screws and frame are not shown in the Figures; however, such screws and frames are broadly used to hold optical elements and adjust the orientation thereof). By operating the screws, the first beam folding mirror E1 is rotated about a first rotation axis P1 coinciding with points where central beams of the two beam paths C1, Cr originating from the object to be observed meet the first beam folding mirror E1. Furthermore, by operating the screws, the first beam folding mirror E1 is rotated about a second rotation axis P2 perpendicular to the first rotation axis P1. Thus, the user can alter an inclination of the first beam folding mirror E1 with respect to two perpendicular directions by operating the screws. Thus, the user can direct a line of sight in directions both up and down and left and right without moving his head.

However, the present application is neither restricted to the above use of screws as actuators for altering the inclination of the first beam folding mirror E1, nor to a tilting of the mirror E1 about a first rotation axis P1 coinciding with points where the central beams meet the mirror. Alternatively, the first rotation axis may even be parallel to the above axis coinciding with the central beams, for example. Further, other means for altering the tilt of the mirror E1 such as step motors or slide-able wedges might be used instead, for example. Moreover, a rotation about only one of the first and second rotation axes P1, P2 might be possible. Further, at least one of the first and second rotation axes P1, P2 might be located either inside or outside of a mathematical plane defined by the mirror E1, for example.

As seen from FIG. 2E, portions of the left and right beam path C1, Cr between the object B and the first beam folding mirror E1 are each free from further beam folding mirrors. The inclination of the first beam folding mirror E1 causes beam paths C1, Cr incident from the object B to be firstly deflected in a vertical direction with respect to the forehead of a user when the head-worn loupe is used. In this respect, “vertical” is vertical not to be interpreted in a literal technical sense but in a sense of upwards or downwards.

If the angle β is below 45°, a user can examine an object B in a plane that is below the straight view of his eyes and thus below the mathematical plane U. If the angle β is above 45°, a user can examine an object B in a plane that is above the straight view of his eyes and thus above the mathematical plane U. This allows the user to maintain his head in an upright position while examining the object using the head-worn loupe.

As is obvious from FIG. 2F, the objective lens F is arranged in the beam paths C1, Cr between the first and second beam folding mirrors E1, E2 such that an optical axis T of the objective lens F includes an angle γ of 90° with the mathematical plane U defined by the optical axes Q1, Qr of the left and right oculars M1, Mr. However, the present invention is not limited to an angle of 90°. To achieve the intended effect it is believed to be sufficient that the angle γ is more than 70° or more than 80°.

Due to the arrangement described above of a first beam folding mirror E1 the left and right beam paths C1, Cr incident from the object B are firstly folded in a direction up with respect to a front of a user's head when the head-mountable loupe is in an observation configuration. Thus, the objective lens F is disposed in the portions of the left and right beam path C1, Cr between the first and second beam folding mirrors E1, E2 wherein the portions of the left and right beam path C1, Cr between the first and second beam folding mirrors E1, E2 are each free of further beam folding mirrors. Consequently the objective lens F can be arranged between a first imaginary plane in which the cover glass D and the first beam folding mirror E1 are arranged, and a second imaginary plane in which the second beam folding mirror E2 and the left and right optical zooms G1, Gr are arranged. In this embodiment, all objective lenses F are arranged in the optical path between the first beam folding mirror E1 and the second beam folding mirror E2. Further, all objective lenses F are commonly interspersed by the left and right stereoscopic beam path C1, Cr. The optical axis T of the objective lens F and the respective optical axes of the left and right optical zooms G1, Gr include an angle of 90°, respectively.

In FIG. 2F, the second beam folding mirror E2 is oriented such that surface normals S2 of the second beam folding mirror E2 meet surface normals S1 of the first beam folding mirror E1 under angles δ within a range from 60° to 110° and especially 60° to 95° (depending on an inclination of the first beam folding mirror E1). FIG. 2A shows an operation stage where angle β is 40° and angle δ is 85°. Thus, the beam paths C1, Cr are oriented downwardly by 10° in FIG. 2A. In FIG. 2B the angle β is 35° and the angle δ is 80°. Thus, the beam paths C1, Cr are oriented downwardly by 20° in FIG. 2B.

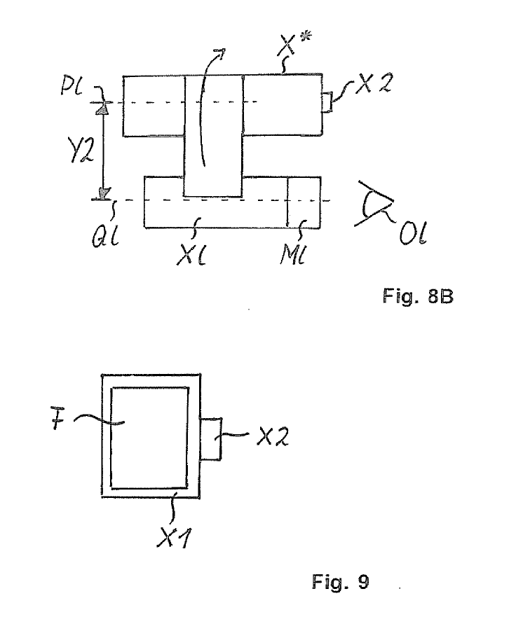

Reference is now made to FIGS. 8A and 8B. FIG. 8A is a perspective view of a chassis X* and a support W*. FIG. 8B is a side view of the chassis X*.

The chassis X* is mounted to support W*. Support W* is attachable to the head of the user. The chassis X* has left and right chassis portions X1, Xr. In FIG. 8A, the support W* is a headband system.

The left and right oculars M1, Mr are mounted in the left and right chassis portions X1, Xr, respectively. The left and right offset-generators J1, Jr are mounted in the connection portions between the chassis X* and the left and right chassis portions X1, Xr, respectively. Further parts of the above described optics are mounted in the chassis X*. Viewing from outside, only the left and right oculars M1, Mr, the cover glass D and the first beam folding mirror E1 can be seen.

It is obvious from FIG. 8A, and the side view shown in FIG. 8B, that the loupe has an observation configuration in which the left and right chassis portions X1, Xr and thus the left and right oculars M1, Mr are disposed in front of the left and right eyes O1, Or of the user. Furthermore, the loupe has a direct view configuration in which the left and right chassis portions X1, Xr and thus the left and right oculars M1, Mr are not disposed in front of the left and right eyes O1, Or of the user, but pivoted away.

To provide the two different configurations, the left and right chassis portions X1, Xr are articulated to the main body of the chassis X*, pivotable about left and right pivoting axis P1, Pr. In FIG. 8A a distance Y1 between the left and right pivoting axis P1, Pr is 62 mm. Furthermore, a distance Y2 between the left pivoting axis P1 and the optical axis Q1 of the left ocular M1 as well as a distance Y2 between the right pivoting axis Pr and the optical axis Qr of the right ocular Mr is 46 mm.

However, the present invention is not limited to the above distances. Thus, the distance Y1 between the left and right pivoting axis P1, Pr may be within 35 mm to 75 mm or especially 40 mm and 75 mm and still achieve the intended effects. Furthermore, to achieve the desirable effects, it is sufficient if the distance Y2 between the left and right pivoting axes P1, Pr and the optical axes Q1, Qr of the corresponding optical left and right oculars M1, Mr is greater than 20 mm or especially greater than 30 mm.

In other words, each of the two oculars M1, Mr is pivotable about a respective pivoting axis P1, Pr, wherein the two pivoting axes P1, Pr are separated both from the optical axis Q1, Qr of the respective ocular M1, Mr and from each other, and wherein the distance between the two pivoting axes P1, Pr ranges from 35 mm to 75 mm, and especially from 40 mm to 75 mm, and further especially is 55 mm.

In the first embodiment the left and right pivoting axes P1, Pr are parallels and located in one common mathematical plane. Moreover, the left pivoting axis P1 coincides with the central beams of an optical path between the reflecting surface 8 of the rhomboid-mirror forming the left offset-generator J1 and the left fourth beam folding mirror E41. The right pivoting axis Pr coincides with central beams of an optical path between the reflecting surface 8 of the rhomboid-mirror forming the right offset-generator Jr and the right fourth beam folding mirror E4r. Reference is made to FIGS. 2F, 8A and 8B.

As is obvious from the above, the left and right offset-generators J1, Jr are used to guarantee that the distance Y2 between the left and right pivoting axes P1, Pr and the optical axes Q1, Qr of the corresponding optical left and right oculars M1, Mr is greater than 20 mm and especially greater than 30 mm. The rhomboid-mirrors each consist of two mirrors that are arranged in a way that reflecting surfaces thereof define basal planes of an imaginary rhomboid having parallel edges of equal length.

Although rhomboid-mirrors are used in the present embodiment as left and right offset-generators J1, Jr, the present invention is not restricted to the use of rhomboid-mirrors. A rhomboid-prism might be used instead, for example. However, usage of rhomboid-mirrors each consisting of two mirrors has the advantage that the weight of the head-mountable loupe is reduced in comparison to the usage of rhomboid-prisms, as prisms have a considerable weight due to the necessary amount of glass.

Due to the above structure, the oculars M1, Mr can be pivoted completely out of view of the eyes O1, Or of the user to easily provide a direct view of the object for the user.

It is important to emphasize with respect to the optics of the first embodiment that the first beam folding mirror E1 and the oculars M1, Mr are positioned on the same side of the chassis X* in the observation configuration of the loupe.

To allow an adaptation to varying working distances while still guaranteeing that the left and right beam paths C1, Cr miter in the object plane A to form the stereoscopic angle α, the objective lens element F is removable in the first embodiment.

Thus, as shown in the top view in FIG. 9, the objective lens F is mounted in a frame structure X1. This frame structure X1 has a handle portion X2 that is exposed to the chassis X* as shown in FIG. 8B. The handle portion X2 allows a user to grasp the frame structure X1 from outside the chassis X* to remove the frame structure X1 together with the objective lens F. In the present embodiment, the frame structure X1 and the objective lens F are moveable in a direction perpendicular to the optical axis T of the objective lens F to remove the objective lens F from the optics of the loupe. In consequence, the objective lens F can be replaced with ease by another objective lens F having a different refraction power. Therefore, the working distance is alterable in steps.

As the objective lens F is shared by both the left and right beam paths C1, Cr, it can be guaranteed that the left and right beam paths C1, Cr intersect at a new working distance Y in the object plane A forming a stereoscopic angle α, provided the optical parameters of the objective lens F are chosen correspondingly. Note that the left and right beam paths C1, Cr traverse the optical lens F not along the optical axis of the objective lens F but at a region different from the optical axis of the objective lens F.

The optical surfaces of the optical elements are specified in FIG. 2C as follows:

A first lens M11 of the left ocular M1 has two optical surfaces 1 and 2, whereas a second lens M21 of the left ocular M1 is a compound lens having three optical surfaces 3, 4 and 5. Reference sign 6 defines an imaginary optical surface covered by the left intermediate picture K1. The rhomboid-mirror of the left optical offset-generator J1 has two reflecting surfaces 7 and 8. A first lens H11 of the left optical tube H1 has two optical surfaces 9 and 10, whereas a second lens H21 of the left optical tube H has three optical surfaces 11, 12 and 13. The prism comprising the left fourth and third beam folding mirrors E41 and E31 has an entrance surface 14, a first reflecting surface 15, a second reflecting surface 16 and an exit surface 17. A first compound lens G11 of the left optical zoom G1 has optical surfaces 18, 19 and 20, a second compound lens G21 of the left optical zoom G1 has optical surfaces 21, 22 and 23, a third compound lens G31 of the left optical zoom G1 has three optical surfaces 24, 25 and 26, and a fourth compound lens G41 of the left optical zoom G1 has three optical surfaces 27, 28 and 29.

The corresponding elements of the right beam path Cr have the same optical surfaces, respectively.

The reflecting surface of the second beam folding mirror E2 is denoted by reference numeral 30. The objective lens F is a compound lens having three optical surfaces 31, 32 and 33. The reflective surface of the first beam folding mirror E1 is denoted by reference numeral 34. The cover glass D has two optical surfaces 35 and 36. The left and right beam paths C1, Cr commonly use these optical elements.

The following table shows the optical parameters of the optics according to the first embodiment:

| surface | | radius | thickness | | clear aperture |
|---|---|---|---|---|---|
| (element) | | (mm) | (mm) | material | (mm) |
| | | | exit pupil N | | |
| | | | 21.0 | air | |
| 1 | (M1l) | plane | | | 14.6 |
| | | | 3.2 | NSK2 | |
| 2 | (M1l) | −17.278 | | | 15.1 |
| | | | 0.1 | air | |
| 3 | (M2l) | 15.650 | | | 15.3 |
| | | | 5.6 | NLAK22 | |
| 4 | (M2l) | −20.684 | | | 14.4 |
| | | | 2.0 | NSF6 | |
| 5 | (M2l) | 33.982 | | | 13.2 |
| | | | 11.83 | air | |
| 6 | (Kl) | plane | | | 11.0 |
| | | | 7.4 | air | |
| 7 | (Jl) | plane | | | 11.0 |
| | | | 46.0 | air | |
| 8 | (Jl) | plane | | | 10.0 |
| | | | 9.0 | air | |
| 9 | (H1l) | −14.698 | | | 10.0 |
| | | | 3.0 | NBK7 | |
| 10 | (H1l) | −24.886 | | | 10.0 |
| | | | 10.0 | air | |
| 11 | (H2l) | 331.697 | | | 10.0 |
| | | | 0.8 | NSSK8 | |
| 12 | (H2l) | 23.828 | | | 10.0 |
| | | | 2.2 | NPK51 | |
| 13 | (H2l) | −24.606 | | | 10.0 |
| | | | 1.5 | air | |
| 14 | (E4l) | plane | | | 10.0 |
| | | | 5.0 | NBK7 | |
| 15 | (E4l) | plane | | | 10.0 |
| | | | 20.0 | NBK7 | |
| 16 | (E3l) | plane | | | 10.0 |
| | | | 5.0 | NBK7 | |
| 17 | (E3l) | plane | | | 10.0 |
| | | | 1.5 | air | |
| 18 | (G1l) | 20.388 | | | 10.0 |
| | | | 0.8 | SNBH51 | |
| 19 | (G1l) | 10.902 | | | 9.8 |
| | | | 2.5 | SPHM53 | |
| 20 | (G1l) | −81.166 | | | 9.6 |
| | | | 0.9 . . . | air | |
| | | | 9.6 . . . 14.0 | | |
| 21 | (G2l) | −27.188 | | | 6.8 |
| | | | 0.8 | NBAF4 | |
| 22 | (G2l) | 7.7179 | | | 6.5 |
| | | | 1.5 | NSF6 | |
| 23 | (G2l) | 15.179 | | | 6.2 |
| | | | 5.9 . . . | air | |
| | | | 1.5 . . . 5.9 | | |
| 24 | (G3l) | −15.179 | | | 6.2 |
| | | | 1.5 | NSF6 | |
| 25 | (G3l) | −7.7179 | | | 6.5 |
| | | | 0.8 | NBAF4 | |
| 26 | (G3l) | 27.188 | | | 6.8 |
| | | | 14.0 . . . | air | |
| | | | 9.6 . . . 0.9 | | |
| 27 | (G4l) | 81.166 | | | 9.6 |
| | | | 2.5 | SPHM53 | |
| 28 | (G4l) | −10.902 | | | 9.8 |
| | | | 0.8 | SNBH51 | |
| 29 | (G4l) | −20.388 | | | 10.0 |
| | | | 6.0 | air | |
| 30 | (E2) | plane | | | 11.0 |
| | | | 6.0 | air | |
| 31 | (F) | 177.830 | | | 11.0 |
| | | | 3.5 | NFK51A | |
| 32 | (F) | −118.850 | | | 11.5 |
| | | | 2.5 | NBAF4 | |
| 33 | (F) | −375.840 | | | 11.5 |
| | | | 7.0 | air | |
| 34 | (E1) | plane | | | 13.0 |
| | | | 9.0 | air | |
| 35 | (D) | plane | | | 15.0 |
| | | | 2.0 | NBK7 | |
| 36 | (D) | plane | | | 15.0 |
| | | | 279.6 | air | |
| | | | object B | | |

In the table, “plane” means that the radius is infinite (∞). It is obvious from the above table that the intermediate pictures K1, Kr, have a diameter of 11 mm. However, the present invention is not limited to this size of the intermediate pictures K1, Kr. To achieve the intended effects, it will usually be sufficient if the diameter of the intermediate picture is below 15 mm and especially below 13 mm. Utilization of such a small intermediate picture K1, Kr allows the use of especially small oculars M1, Mr. The small size of the intermediate pictures K1, Kr is caused by the diameter of the entrance pupils of the optics. The distance of 46.0 mm between the two surfaces 7 and 8 of the left optical offset-generator J1 corresponds to the distance Y2 between the left pivoting axis P1 and the optical axis Q1 of the left ocular M1.

The focal lengths of the replaceable objective lenses that might be used are e.g. f=300 mm, f=400 mm, f=500 mm, f=600 mm and f=700 mm. The optical zoom has a factor of Γ=0.5-2.0. The focal length of the tube is f=90 mm. A 14×/11 ocular is used.

In cases in which the first beam folding mirror E1 and the oculars Mr are arranged on the same side of the chassis X in the observation configuration of the head-mountable loupe (as it is the case in the present embodiment) it is preferred that the angle β is within a range from 20° to 50° and especially from 30° to 45°.

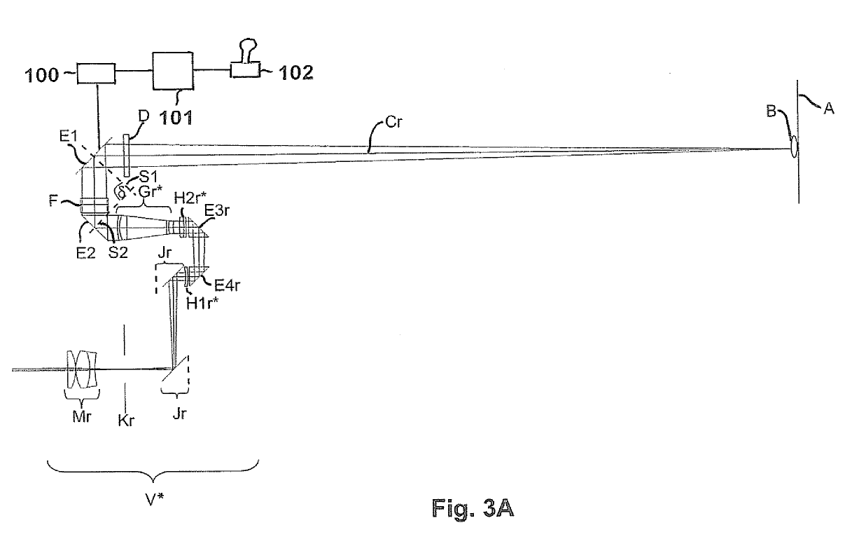

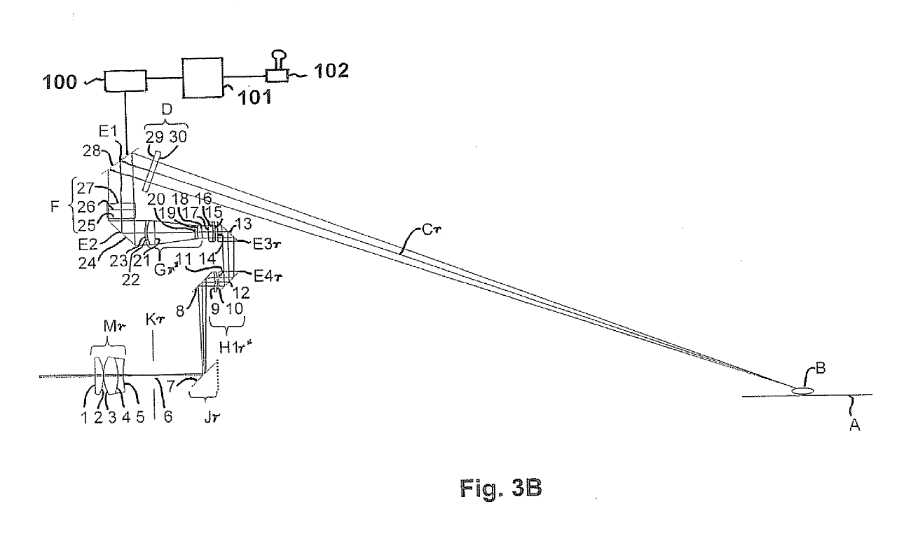

In the following, the optics V* of a head-mountable loupe according to a second embodiment of the present invention are described with reference to FIGS. 3A and 3B. The optics of the second embodiment has a similar structure to the optics of the first embodiment. Therefore, in the following only the differences will be described in more detail.

FIGS. 3A and 3B each show side views of the optics that is unfolded in one plane. To increase the clarity of the Figures, only the right beam path Cr and the optical elements used by the right beam path Cr are shown.

A major difference between the optics of the first and second embodiment is that according to the second embodiment, the first beam folding mirror E1 and the oculars Mr are arranged on opposing sides of the chassis X in the observation configuration of the head-mountable loupe.

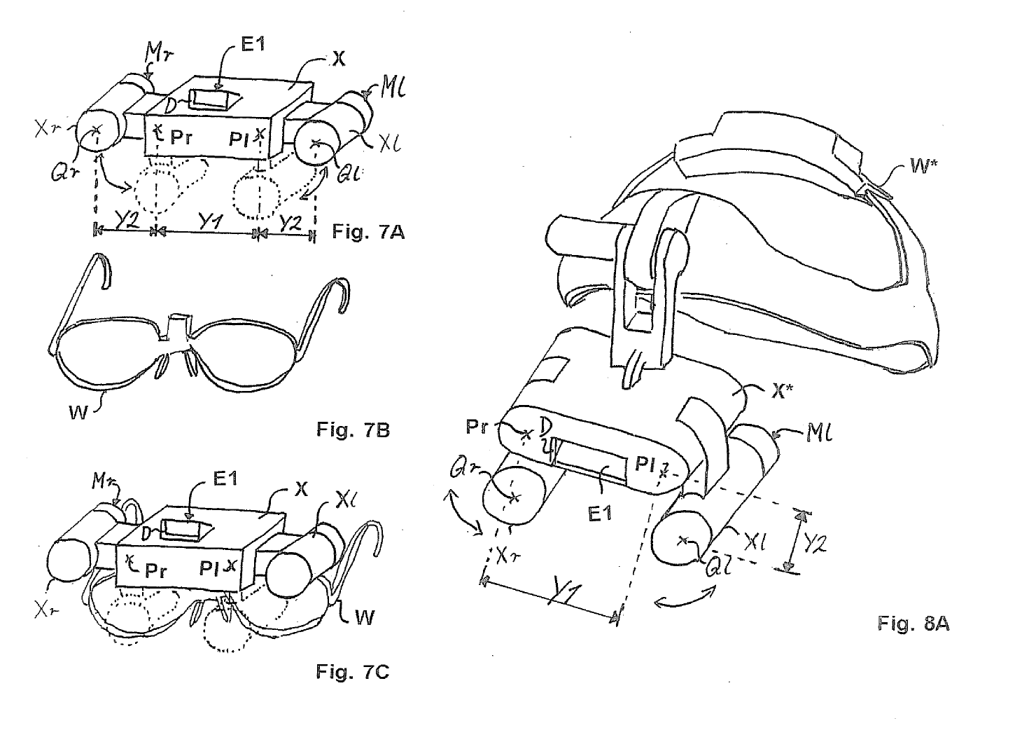

This is more obvious from FIG. 7A showing a chassis X in which the optics of the second embodiment are mounted.

The chassis X in which the optics according to the second embodiment are mounted may be attached to a support W being a reinforced eyeglass frame as it is shown in FIGS. 7B and 7C. Alternatively, the chassis may be attached to a headband system as shown in FIG. 8A, for example.

A further difference between the optics according to the first and second embodiment is that the magnification-changer Gr* according to the second embodiment is not an optical zoom as in the first embodiment. Thus, the magnification-changer Gr* does not have moveable lenses. According to the second embodiment, the magnification-changer Gr* comprises two optical compound lenses, a first lens having surfaces 18, 19 and 20, and a second lens having surfaces 21, 22 and 23. By rotating the two lenses around a pivoting axis that is oriented perpendicular to the direction of the optical axes of the lenses and in the middle of the two lenses, the positions of the two lenses in the beam path Cr can be exchanged. Alternatively, the magnification-changer Gr* simply might be removed from the optics and exchanged for another magnification-changer Gr*. Thus, the magnification provided by the optics can be altered.

In FIG. 3A the angle δ between the surface normals S1, S2 of the first and second beam folding mirrors E1, E2 is 90° whereas in FIG. 3B the angle δ is 70°. However, the present invention is not restricted to these values. It is generally sufficient if the angle δ ranges from 60° to 110° and especially 60° to 95°.

Furthermore, in FIG. 3A angle β between the surface normals S1 between the first beam folding mirror E1 and the mathematical plane U defined by the optical axes of the oculars Mr is 45°, whereas in FIG. 3B the angle β is 55°. Thus, the optics of FIG. 3A provide a straight view parallel to the optical axis of the ocular Mr, whereas the optics of FIG. 3B provide a view that is directed downwardly by 20° with respect to an optical axis of the objective Mr. However, the present invention is not restricted to these values. To achieve the intended effects of the present invention, it is generally sufficient if angle β ranges from 20° to 65°.

In the present embodiment, the angle β between the surface normals S1 of the first beam folding mirror E1 and the mathematical plane U can be altered from 45° to 65° by tilting the mirror E1 about only one single rotation axis by using a stepper motor 100. The rotation axis coincides with the surface of the first beam folding mirror E1 and corresponds to the first rotation axis P1 defined in the first embodiment. A controller 101 controls the stepper motor 100. The controller 101 is connected to a user interface 102 to receive an input from a user. In the Figures, the user interface 102 is a joystick. Alternatively, a voice-operated or tongue-operated user interface might be used instead, for example.

According to a variation of the second embodiment, the motor 100 can tilt the first beam folding mirror E1 about two orthogonal rotation axes P1, P2 as shown in FIG. 2F of the first embodiment. In this alternative embodiment, a vibration sensor replaces the user interface 102. The vibration sensor detects vibrations of the head-mountable loupe. A user usually causes such vibrations by moving his head without intension. In this case, the controller 101 automatically operates the stepper motor 100 in dependency on vibrations detected by the vibration sensor to reduce jitter in the image generated by the head-mountable loupe by tilting the first beam folding mirror E1 correspondingly.

Similar to the first embodiment, the objective lens F is mounted on a frame structure X1 comprising a handle portion X2 as shown in FIG. 9. Thus, the objective lens F is exchangeable to adjust the lens to different working distances. However, exchangeability of the objective lens F is only optional.

Optical parameters of the objects according to the second embodiments are given in the following table. The corresponding optical surface are denoted in FIG. 3B.

| surface | | radius | thickness | | clear aperture |
|---|---|---|---|---|---|
| (element) | | (mm) | (mm) | material | (mm) |
| | | | exit pupil N | | |
| | | | 22.0 | air | |
| 1 | (Mr) | plane | | | 14.6 |
| | | | 3.2 | NSK2 | |
| 2 | (Mr) | −17.278 | | | 15.1 |
| | | | 0.1 | air | |
| 3 | (Mr) | 15.650 | | | 15.3 |
| | | | 5.6 | NLAK22 | |
| 4 | (Mr) | −20.684 | | | 14.4 |
| | | | 2.0 | NSF6 | |
| 5 | (Mr) | 33.982 | | | 13.2 |
| | | | 11.829 | air | |
| 6 | (Kr) | plane | | | 11.0 |
| | | | 19.617 | air | |
| 7 | (Jr) | plane | | | 10.0 |
| | | | 37.0 | air | |
| 8 | (Jr) | plane | | | 9.2 |
| | | | 5.0 | air | |
| 9 | (H1r*) | −17.403 | | | 8.0 |
| | | | 1.0 | NSF1 | |
| 10 | (H1r*) | −20.242 | | | 8.0 |
| | | | 0.5 | air | |
| 11 | (E4r) | plane | | | 8.0 |
| | | | 4.0 | NSK2 | |
| 12 | (E4r) | plane | | | 8.0 |
| | | | 20.0 | NSK2 | |
| 13 | (E3r) | plane | | | 8.0 |
| | | | 4.0 | NSK2 | |
| 14 | (E3r) | plane | | | 8.0 |
| | | | 1.0 | air | |
| 15 | (H2r*) | 244.060 | | | 8.0 |
| | | | 0.8 | NSSK2 | |
| 16 | (H2r*) | 33.982 | | | 8.0 |
| | | | 1.8 | NPK51 | |
| 17 | (H2r*) | −36.517 | | | 8.0 |
| | | | 2.5 | air | |
| 18 | (Gr*) | −12.144 | | | 5.0 |
| | | | 1.8 | NSF6 | |
| 19 | (Gr*) | −6.9783 | | | 5.3 |
| | | | 0.8 | NBAF52 | |
| 20 | (Gr*) | 40.679 | | | 5.5 |
| | | | 15.643 | air | |
| 21 | (Gr*) | 92.39 | | | 9.6 |
| | | | 3.0 | NPSK53A | |
| 22 | (Gr*) | −11.885 | | | 9.8 |
| | | | 0.8 | OSNBH51 | |
| 23 | (Gr*) | −24.406 | | | 10.0 |
| | | | 9.0 | air | |
| 24 | (E2) | plane | | | 11.0 |
| | | | 6.0 | air | |
| 25 | (F) | 177.830 | | | 11.0 |
| | | | 3.5 | NFK51A | |
| 26 | (F) | −118.850 | | | 11.0 |
| | | | 2.5 | NBAF4 | |
| 27 | (F) | −375.840 | | | 11.0 |
| | | | 17.0 | air | |
| 28 | (E1) | plane | | | 15.0 |
| | | | 12.0 | air | |
| 29 | (D) | plane | | | 17.0 |
| | | | 2.0 | NBK7 | |
| 30 | (D) | plane | | | 17.0 |
| | | | 266.6 | air | |
| | | | object B | | |

As in the first embodiments, the focal lengths of the replaceable objective lenses that might be used are e.g. f=300 mm, f=400 mm, f=500 mm, f=600 mm and f=700 mm. The optical magnification changer Gr* has a factor of Γ=0.5, 0.7, 1.0, 1.4 and 2.0 in dependency on the order and orientation of the lenses. The focal length of the tube is f=90 mm. A 14×/11 ocular is used.

It is obvious from the above table that the distance of 37.0 mm between the two surfaces 7 and 8 of the left optical offset-generator J1 corresponds to the distance Y2 between the left pivoting axis P1 and the optical axis Q1 of the left ocular M1. However, the present invention is not restricted to this value of Y2. It is generally sufficient if this distance is more than 20 mm and especially more than 30 mm.

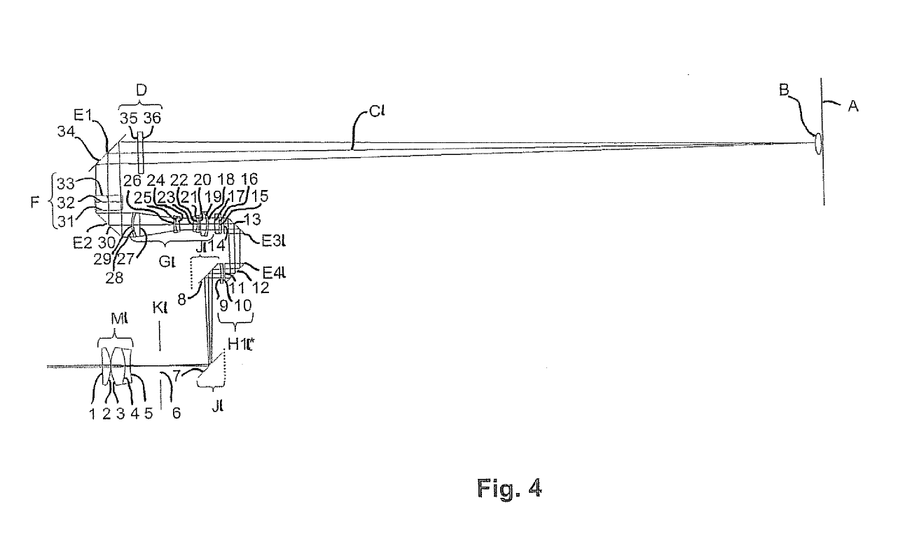

FIG. 4 shows a side view of the optics according to a third embodiment of the present invention, wherein the optics are enfolded in one plane. The optics of the third embodiment has a similar structure to the optics of the second embodiment. Therefore, in the following only the differences will be described in more detail.

To increase the clarity of the Figures, only the left beam path C1 and the optical elements used by the left beam path C1 are shown. However, as in all embodiments the left and the right beam path have an identical structure. The separate optical elements of the left and the right beam path are arranged symmetrically about a common optical axis of the head-mountable loupe. This common optical axis coincides with the optical axis of the objective lens F that is commonly used by both the left and right beam paths C1, Cr.

The third embodiment shown in FIG. 4 differs from the second embodiment shown in FIGS. 3A and 3B in that the magnification changer of the third embodiment is an optical zoom. A first compound lens of the optical zoom G1 has optical surfaces 18, 19 and 20, a second compound lens of the optical zoom G1 has optical surfaces 21, 22 and 23, a third compound lens of the optical zoom G1 has three optical surfaces 24, 25 and 26 and a fourth compound lens of the optical zoom G1 has three optical surfaces 27, 28 and 29. The two middle lenses of the optical zoom G1 are moveable with respect to the two outer lenses along the optical axis of the zoom to change the magnification of the loupe.

It can be seen from FIG. 4, that the optics provides a straight view of the beam path C1 parallel to the optical axis of the ocular M1. Thus, In FIG. 4 the angle δ between the surface normals S1, S2 of the first and second beam folding mirrors E1, E2 is 90° whereas angle β between the surface normals S1 between the first beam folding mirror E1 and the mathematical plane U defined by the optical axes of the oculars M1 is 45°. However, as already stated with respect to the second embodiment the present invention is not restricted to these angles. The angle δ may range from 60° to 110° and the angle β may range from 20° to 65°. In cases in which the first beam folding mirror E1 and the oculars Mr are arranged on opposing sides of the chassis X in the observation configuration of the head-mountable loupe it is preferred that angle β ranges from 40° to 65°.

The optics of the third embodiment may be mounted in a chassis similar to the chassis X of FIG. 7A that can be attached to the head of a user by a suitable support W. It is preferable if the support is made of a light material such as plastic or a light metal such as titanium or aluminum.

The optical parameters of the optical surfaces denoted in FIG. 4 are shown in the following table:

| surface | | radius | thickness | | clear aperture |
|---|---|---|---|---|---|
| (element) | | (mm) | (mm) | material | (mm) |
| | | | exit pupil N | | |
| | | | 22.0 | air | |
| 1 | (Ml) | plane | | | 14.6 |
| | | | 3.2 | NSK2 | |
| 2 | (Ml) | −17.278 | | | 15.1 |
| | | | 0.1 | air | |
| 3 | (Ml) | 15.650 | | | 15.3 |
| | | | 5.6 | NLAK22 | |
| 4 | (Ml) | −20.684 | | | 14.4 |
| | | | 2.0 | NSF6 | |
| 5 | (Ml) | 33.982 | | | 13.2 |
| | | | 11.829 | air | |
| 6 | (Kl) | plane | | | 11.0 |
| | | | 19.617 | air | |
| 7 | (Jl) | plane | | | 10.0 |
| | | | 37.0 | air | |
| 8 | (Jl) | plane | | | 9.2 |
| | | | 5.0 | air | |
| 9 | (H1l*) | −17.403 | | | 8.0 |
| | | | 1.0 | NSF1 | |
| 10 | (H1l*) | −20.242 | | | 8.0 |
| | | | 0.5 | air | |
| 11 | (E4l) | plane | | | 8.0 |
| | | | 4.0 | NSK2 | |
| 12 | (E4l) | plane | | | 8.0 |
| | | | 20.0 | NSK2 | |
| 13 | (E3l) | plane | | | 8.0 |
| | | | 4.0 | NSK2 | |
| 14 | (E3l) | plane | | | 8.0 |
| | | | 1.0 | air | |
| 15 | | 244.060 | | | 8.0 |
| | | | 0.8 | NSSK2 | |
| 16 | | 33.982 | | | 8.0 |
| | | | 1.8 | NPK51 | |
| 17 | | −36.517 | | | 8.0 |
| | | | 2.5 | air | |
| 18 | (Gl) | 20.8121 | | | 10.0 |
| | | | 0.6 | LAFN7 | |
| 19 | (Gl) | 10.6367 | | | 9.8 |
| | | | 2.5 | NPSK53 | |
| 20 | (Gl) | −76.5687 | | | 9.5 |
| | | | 0.6 . . . | air | |
| | | | 9.2 . . . 13.5 | | |
| 21 | (Gl) | −25.5442 | | | 7.0 |
| | | | 0.6 | NBAF4 | |
| 22 | (Gl) | 7.5538 | | | 6.5 |
| | | | 1.5 | NSF6 | |
| 23 | (Gl) | 15.1096 | | | 6.0 |
| | | | 5.5 . . . | air | |
| | | | 1.2 . . . 5.5 | | |
| 24 | (Gl) | −15.1096 | | | 6.0 |
| | | | 1.5 | NSF6 | |
| 25 | (Gl) | −7.5538 | | | 6.5 |
| | | | 0.6 | NBAF4 | |
| 26 | (Gl) | 25.5442 | | | 7.0 |
| | | | 13.5 . . . | air | |
| | | | 9.2 . . . 0.6 | | |
| 27 | (Gl) | 76.5686 | | | 9.5 |
| | | | 2.5 | NPSK53 | |
| 28 | (Gl) | −10.6367 | | | 9.8 |
| | | | 0.6 | LAFN7 | |
| 29 | (Gl) | −20.8120 | | | 10.0 |
| | | | 9.0 | air | |
| 30 | (E2) | plane | | | 11.0 |
| | | | 6.0 | air | |
| 31 | (F) | 177.830 | | | 11.0 |
| | | | 3.5 | NFK51A | |
| 32 | (F) | −118.850 | | | 11.0 |
| | | | 2.5 | NBAF4 | |
| 33 | (F) | −375.840 | | | 11.0 |
| | | | 17.0 | air | |
| 34 | (E1) | plane | | | 15.0 |
| | | | 12.0 | air | |
| 35 | (D) | plane | | | 17.0 |
| | | | 2.0 | NBK7 | |
| 36 | (D) | plane | | | 17.0 |
| | | | 266.6 | air | |
| | | | object B | | |

As in the first and second embodiments, the focal lengths of the replaceable objective lenses that might be used are e.g. f=300 mm, f=400 mm, f=500 mm, f=600 mm and f=700 mm. The optical zoom has a factor of Γ=0.5-2.0. The focal length of the tube is f=90 mm. A 14×/11 ocular is used.

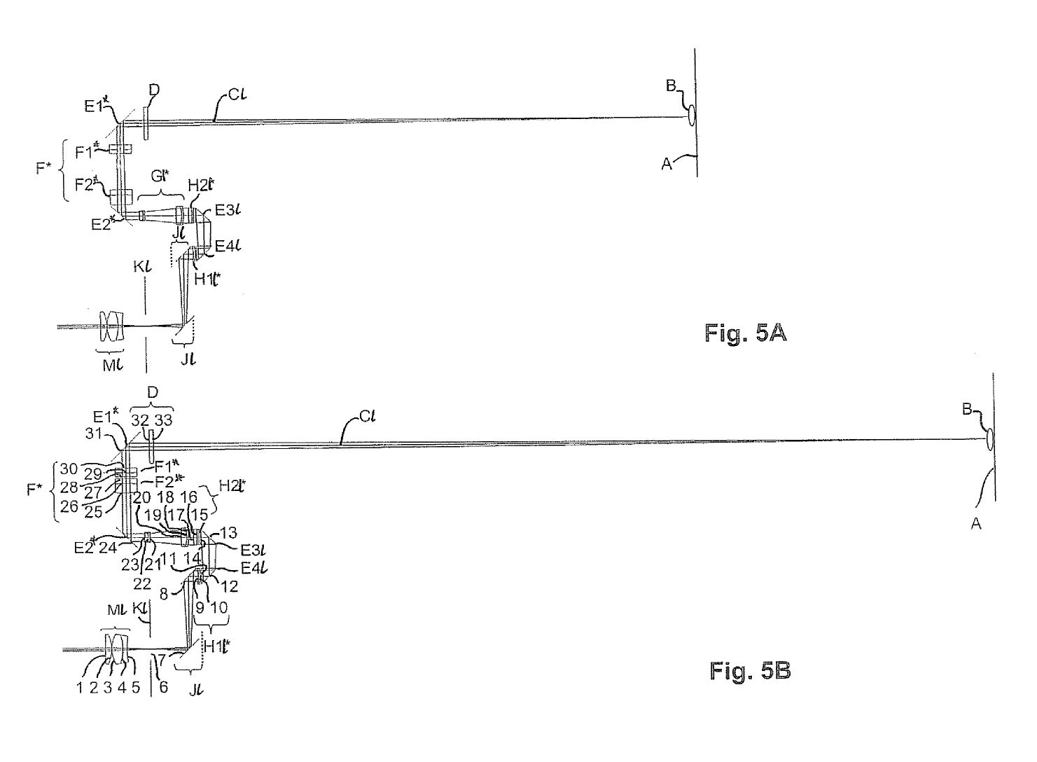

FIGS. 5A and 5B each show a side view of the optics of a head-mountable loupe according to a fourth embodiment of the present invention, wherein the optics is unfolded in one plane. The optics of the fourth embodiment has a structure similar to the optics of the second embodiment. Therefore, in the following only the differences will be described in more detail.

The optics of the fourth embodiment differ from the optics of the second embodiment in that the single objective lens F of the second embodiment is replaced by an objective system F*, comprising a first objective lens element F1* and a second objective lens element F2*. The second objective lens element F2* is displaceable relative to the first optical lens element F1* by using an actuator (not shown in the figures). By varying the distance between the first and second objective lens elements F1*, F2*, the working distance (distance of an object plane A of the loupe from the left and right oculars M1) can be altered. This is shown by comparing FIGS. 5A and 5B. In FIG. 5A, the working distance is 275 mm, while in FIG. 5B the working distance is 425 mm. However, the present invention is not limited to these values of the working distance.

The first objective lens element F1* comprises optical surfaces 30, 29 and 28 and the second objective lens element F2* comprises optical surfaces 27, 26 and 25. Thus, both objective lens elements F1* and F2* are compound lenses.

In the embodiment shown in FIGS. 5A and 5B, the cover glass D, the first beam folding mirror E1*, the objective system F* and the second beam folding mirror E2* are each commonly used by the left and right beam paths C1. However, in this embodiment the first beam folding mirror E1 and the second beam folding mirror E2 each comprise two separate reflecting surfaces for the left and right optical beam paths C1.

As in the second and third embodiments, the magnification-changer G1*, the optical elements H11* and H21* of the optical tube, the third and fourth beam folding mirrors E31, E41, the offset-generator J1 and the ocular M1 each are provided twice, once for the left beam path C1, and a second time for the right beam path. However, to increase the clarity of the Figures, only the optical elements used by the left beam path C1 are shown in the Figures.

The optical parameters of the optical surfaces denoted in FIG. 5B are shown in the following table:

| surface | | radius | thickness | | clear aperture |
|---|---|---|---|---|---|
| (element) | | (mm) | (mm) | material | (mm) |
| | | | Exit pupil N | | |
| | | | 22.0 | air | |
| 1 | (Ml) | plane | | | 14.6 |
| | | | 3.2 | NSK2 | |
| 2 | (Ml) | −17.278 | | | 15.1 |
| | | | 0.1 | air | |
| 3 | (Ml) | 15.650 | | | 15.3 |
| | | | 5.6 | NLAK22 | |
| 4 | (Ml) | −20.684 | | | 14.4 |
| | | | 2.0 | NSF6 | |
| 5 | (Ml) | 33.982 | | | 13.2 |
| | | | 11.829 | air | |
| 6 | (Kl) | plane | | | 11.0 |
| | | | 19.617 | air | |
| 7 | (Jl) | plane | | | 10.0 |
| | | | 37.0 | air | |
| 8 | (Jl) | plane | | | 9.2 |
| | | | 5.0 | air | |
| 9 | (H1l*) | −17.403 | | | 8.0 |
| | | | 1.0 | NSF1 | |
| 10 | (H1l*) | −20.242 | | | 8.0 |
| | | | 0.5 | air | |
| 11 | (E4l) | plane | | | 8.0 |
| | | | 4.0 | NSK2 | |
| 12 | (E4l) | plane | | | 8.0 |
| | | | 20.0 | NSK2 | |
| 13 | (E3l) | plane | | | 8.0 |
| | | | 4.0 | NSK2 | |
| 14 | (E3l) | plane | | | 8.0 |
| | | | 1.0 | air | |
| 15 | (H2l*) | 244.060 | | | 8.0 |
| | | | 0.8 | NSSK2 | |
| 16 | (H2l*) | 33.982 | | | 8.0 |
| | | | 1.8 | NPK51 | |
| 17 | (H2l*) | −36.517 | | | 8.0 |
| | | | 2.5 | air | |
| 18 | (Gl*) | −12.144 | | | 5.0 |
| | | | 1.8 | NSF6 | |
| 19 | (Gl*) | −6.9783 | | | 5.3 |
| | | | 0.8 | NBAF52 | |
| 20 | (Gl*) | 40.679 | | | 5.5 |
| | | | 15.643 | air | |
| 21 | (Gl*) | 92.39 | | | 9.6 |
| | | | 3.0 | NPSK53A | |
| 22 | (Gl*) | −11.885 | | | 9.8 |
| | | | 0.8 | OSNBH51 | |
| 23 | (Gl*) | −24.406 | | | 10.0 |
| | | | 9.0 | air | |
| 24 | (E2*) | plane | | | 11.0 |
| | | | 6.0 . . . 23.0 | air | |
| 25 | (F2*) | 124.5648 | | | 11.0 |
| | | | 5.0 | NSSK8 | |
| 26 | (F2*) | −62.0966 | | | 11.0 |
| | | | 2.5 | NSF56 | |
| 27 | (F2*) | −158.697 | | | 11.0 |
| | | | 18.0 . . . 1.0 | air | |
| 28 | (F1*) | 793.7678 | | | 11.0 |
| | | | 2.0 | NSSK8 | |
| 29 | (F1*) | 55.8294 | | | 11.0 |
| | | | 2.5 | NSF6 | |
| 30 | (F1*) | 84.4148 | | | 11.0 |
| | | | 11.0 | air | |
| 31 | (E1*) | plane | | | 15.0 |
| | | | 12.0 | air | |
| 32 | (D) | plane | | | 17.0 |
| | | | 2.0 | NBK7 | |
| 33 | (D) | plane | | | 17.0 |
| | | | 275.7 . . . 425.7 | air | |
| | | | object B | | |

The working distance of the loupe is variable from 275 mm to 425 mm. The optical magnification changer G1* has a factor of Γ=0.5, 0.7, 1.0, 1.4 and 2.0 in dependency on the order and orientation of the lenses. The focal length of the tube is f=90 mm. A 14×/11 ocular is used as in the above embodiments.

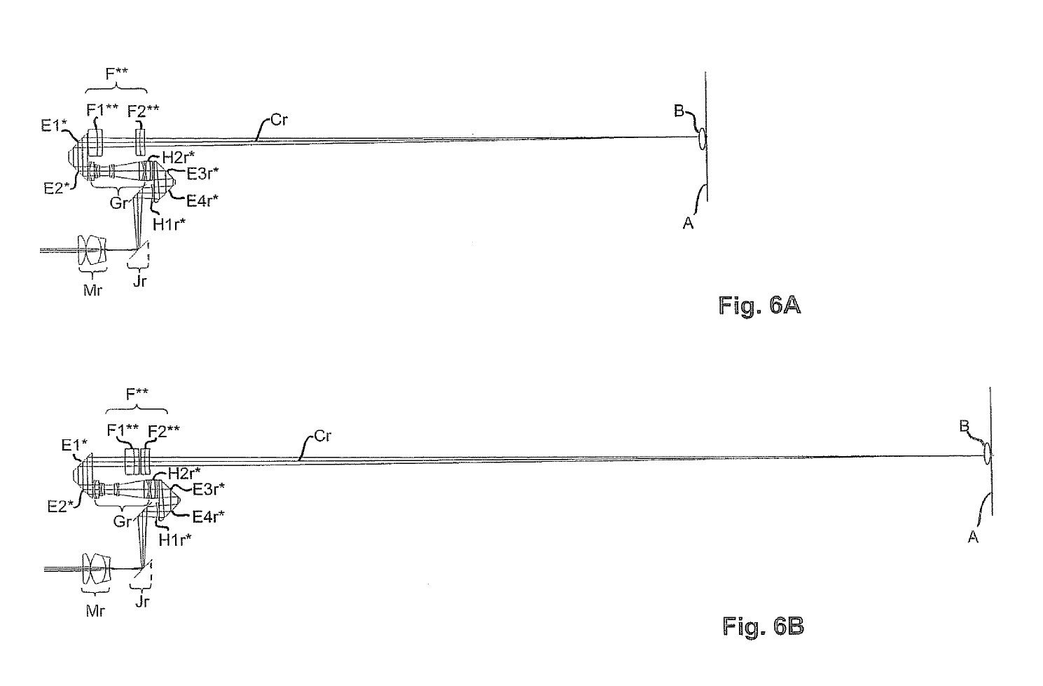

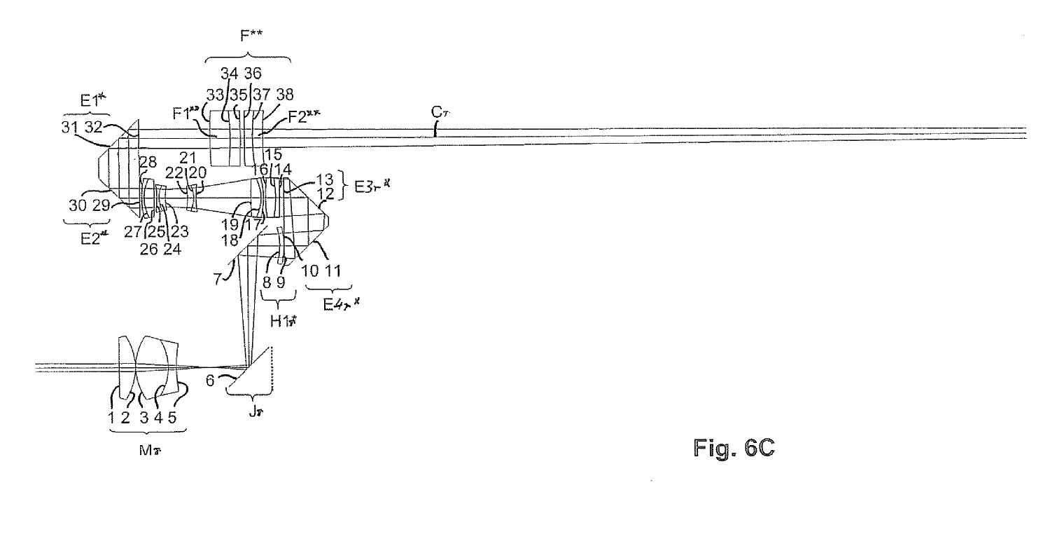

Finally, optics according to a fifth embodiment of the present invention are shown in FIGS. 6A to 6C. FIGS. 6A to 6B each show a side view of the optics, wherein the optics is unfolded in one plane. As in the above second to fourth embodiments, only the optical elements used by one (right) beam path Cr are shown to increase clarity of the Figures.

The optics of the fifth embodiment has a similar structure as the optics of the third embodiment. Therefore, in the following only the differences will be described in more detail.

The optics of the fifth embodiment differ from the optics of the third embodiment basically in that the single objective lens F of the third embodiment is replaced by an objective system F** comprising two objective lens elements F1** and F2**. Moreover, the first and second objective lens element F1** and F2** are arranged in the portions of a left and right beam paths Cr disposed between the object B and the first beam folding mirror E1*. Both the first and the second objective lens element F1** and F2** are single compound lens elements traversed by both the left and right beam path Cr. The first objective lens element F1** is displaceable with respect to the second objective lens element F2** using an actuator (not shown) to adjust a working distance of the object plane A of the loupe from the left and right oculars Mr. As the second objective lens element F2** is located at a fixed position, the second objective lens element F2** also serves to seal the optics against dust. Thus, the cover glass is avoided in this embodiment.

Moreover, other than in the third embodiment, the first and second beam folding mirrors E1* and E2* are realized by reflecting surfaces 31, 30 of a prism. The prism further has an entrance surface 32 and an exit surface 29. The left and right third and fourth beam folding mirrors E3* and E4* each are realized by reflecting surfaces 12, 11 of two prisms. The prisms further have an entrance surface 13 and an exit surface 10. The first and second objective lens elements F1** and F2** as well as the prism providing the first and second beam folding mirrors E1* and E2* are commonly traversed by both the left and right beam paths Cr. The usage of a prism for the first and second beam folding mirrors E1* and E2* as well as two prisms for the left and right third and fourth beam folding mirrors E3r* and E4r* makes it obvious that the first to fourth beam folding mirrors E1* to E4r are arranged such that they form a Porro-prism-system of the first kind. Thus, they provide an image reversal.

Using the prisms for the beam folding mirrors in combination with the arrangement of the objective system F** between the object B and the first beam folding mirror E1* significantly reduces the total size of the loupe. Thus, the loupe according to this embodiment has an especially compact structure. One reason is that the size of the objective system F** is about the same as the size of the optical zoom Gr.

In this embodiment, the distance Y1 between the left and right pivoting axis P1, Pr is 46 mm. The distance Y2 between the left pivoting axis P1 and the optical axis Q1 of the left ocular M1 as well as a distance Y2 between the right pivoting axis Pr and the optical axis Qr of the right ocular Mr is 30.515 mm. However, the present invention is not restricted to these values. It is generally sufficient if Y1 ranges from 35 mm to 75 mm and especially from 40 mm to 75 mm and Y2 is more than 20 mm and especially more than 30 mm.

The optical parameters of the optical surfaces denoted in FIG. 6C are shown in the following table:

| surface | | radius | thickness | | clear aperture |
|---|---|---|---|---|---|
| (element) | | (mm) | (mm) | material | (mm) |
| | | | exit pupil N | | |
| | | | 20.7 | air | |
| 1 | (Mr) | plane | | | 15.0 |
| | | | 4.0 | NSK2 | |
| 2 | (Mr) | −14.6014 | | | 16.0 |
| | | | 0.1 | air | |
| 3 | (Mr) | 13.9603 | | | 16.0 |
| | | | 8.0 | NSK2 | |
| 4 | (Mr) | −13.2898 | | | 14.0 |
| | | | 2.0 | SF57 | |
| 5 | (Mr) | 34.3571 | | | 12.0 |
| | | | 17.864 | air | |
| 6 | (Jr) | plane | | | 10.0 |
| | | | 30.515 | air | |
| 7 | (Jr) | plane | | | 10.0 |
| | | | 8.0 | air | |
| 8 | (H1r*) | −15.1525 | | | 9.0 |
| | | | 1.0 | NSK2 | |
| 9 | (H1r*) | −22.2291 | | | 9.5 |
| | | | 0.1 | air | |
| 10 | (E4r*) | plane | | | 10.0 |
| | | | 6.0 | NBK7 | |
| 11 | (E4r*) | plane | | | 10.0 |
| | | | 12.0 | NBK7 | |
| 12 | (E3r*) | plane | | | 10.0 |
| | | | 6.0 | NBK7 | |
| 13 | (E3r*) | plane | | | 10.0 |
| | | | 1.0 | air | |
| 14 | (H2r*) | 144.6922 | | | 10.0 |
| | | | 1.0 | NSF4 | |
| 15 | (H2r*) | 29.1357 | | | 10.0 |
| | | | 2.5 | NBAF52 | |
| 16 | (H2r*) | −31.2576 | | | 10.0 |
| | | | 0.5 | air | |
| 17 | (Gr) | 20.8120 | | | 10.0 |
| | | | 0.6 | LAFN7 | |
| 18 | (Gr) | 10.6367 | | | 9.8 |
| | | | 2.5 | NPSK53 | |
| 19 | (Gr) | −76.5686 | | | 9.5 |
| | | | 13.5 | air | |
| 20 | (Gr) | −25.5442 | | | 7.0 |
| | | | 0.6 . . . | NBAF4 | |
| | | | 9.2 . . . 13.5 | | |
| 21 | (Gr) | 7.5538 | | | 6.5 |
| | | | 1.5 | NSF6 | |
| 22 | (Gr) | 15.1096 | | | 6.0 |
| | | | 5.5 . . . | air | |
| | | | 1.2 . . . 5.5 | | |
| 23 | (Gr) | −15.1096 | | | 6.0 |
| | | | 1.5 | NSF6 | |
| 24 | (Gr) | −7.5538 | | | 6.5 |
| | | | 0.6 | NBAF4 | |
| 25 | (Gr) | 25.5442 | | | 7.0 |
| | | | 13.5 . . . | air | |
| | | | 9.2 . . . 0.6 | | |
| 26 | (Gr) | 76.5687 | | | 9.5 |
| | | | 2.5 | NPSK53 | |
| 27 | (Gr) | −10.6367 | | | 9.8 |
| | | | 0.6 | LAFN7 | |
| 28 | (Gr) | −20.8121 | | | 10.0 |
| | | | 0.5 | air | |
| 29 | (E2*) | plane | | | 10.0 |
| | | | 5.0 | NBK7 | |
| 30 | (E2*) | plane | | | 10.0 |
| | | | 15.0 | NBK7 | |
| 31 | (E1*) | plane | | | 10.0 |
| | | | 5.0 | NBK7 | |
| 32 | (E1*) | plane | | | 10.0 |
| | | | 0.5 . . . 17.5 | air | |
| 33 | (F1**) | 124.5648 | | | 14.0 |
| | | | 5.0 | NSSK8 | |
| 34 | (F1**) | −62.0966 | | | 14.0 |
| | | | 2.5 | NSF56 | |
| 35 | (F1**) | −158.6970 | | | 14.0 |
| | | | 18.0 . . . 1.0 | air | |
| 36 | (F2**) | 793.7678 | | | 14.0 |
| | | | 2.0 | NSSK8 | |
| 37 | (F2**) | 55.8294 | | | 14.0 |
| | | | 2.5 | NSF6 | |
| 38 | (F2**) | 84.4148 | | | 14.0 |
| | | | 300 . . . 450 | air | |
| | | | object B | | |

The working distance of the loupe is variable from 300 mm to 450 mm. The optical zoom has a factor of f=0.5-2.0. The focal length of the tube is f=80 mm. A 16×/10 ocular is used.

In the above tables of optical parameters of the embodiments, glass available from the companies SCHOTT AG, Hattenbergstr. 10, 55122 Mainz, Germany and OHARA GmbH, Nordring 30 A, 65719 Hofheim, Germany has been used as optical material.

In all of the above embodiments, the objective lens F and objective lens system F*, F**, respectively, images stereoscopic beam paths C1, Cr incident from the object plane B to infinity (∞). Moreover, the magnification-changers G, G* image beam paths C1, Cr incident from the objective lens F and objective lens system F*, F**, respectively, to infinity. This allows a modular structure of the loupe as afocal interfaces are provided. However, it is emphasized that the present invention is not restricted to cases where afocal interfaces of the beam paths are provided between the objective lens F, objective lens systems F*, F** and the magnification-changer G, G* and the optical tube H, respectively.

Moreover, in all of the above embodiments, the imaging of the object B located in the object plane A is performed in two steps by using intermediate pictures K1, Kr.

In the embodiments, the first to fourth beam folding mirrors E1, E2, E31, E3r, E41, E4r are oriented such that they optically form a Porro-system of the first kind with respect to the left and right beam paths C1, Cr. Thus, they achieve an image reversal.

Moreover, in some of the above embodiments, the inclination of the first beam folding mirror E1 can be adjusted by the user. However, the present invention is not limited to this case. The inclination of the first beam folding mirror may be predefined when the loupe is manufactured, and thus be adjustable only during manufacturing of the loupe.

The head-mountable loupe of all the embodiments has a very light weight, a small construction volume, and allows a direct view by a user of the loupe in an easy and convenient way. A variation of a magnification of the loupe is achieved either by a zoom system or interchangeable lenses. To account for different working distances, it is proposed to use one single objective lens F that is displaceable by another objective lens having a different refraction force by a user. Alternatively, an objective lens system F*, F** consisting of two or more objective lens elements F1*, F2*, F1**, F2** is proposed, wherein a distance between at least two of these objective lens elements F1*, F2*, F1**, F2**is variable along an optical axis of the objective lens system F*, F**.

A total magnification achieved by the loupes of the embodiments described above is about 8 to 10 times. This is sufficient for head-mountable loupes. In case of a greater magnification, it would be very hard to maintain a stable image without image stabilization. An angle of the field of vision is about 35°.

A distance between the left and right exit pupils N1, Nr and the next optical element of the left and right oculars M1, Mr is more 20 mm. Thus, a user may wear ophthalmic glasses if required. A diameter of the exit pupil is about 1 mm.

In some of the above embodiments, the entrance pupil is located in the area of the magnification-changer G, G* between the second and third beam folding mirrors E31, E3r, E41, E4r.

In the above embodiments, reflecting surfaces of the left third and fourth beam folding mirrors E31, E41 are each located in mathematical planes that intersect with an angle of 90°. The same applies to the reflecting surfaces of the right third and fourth beam folding mirrors E3r, E4r. However, the present invention is not restricted to such an arrangement.

While the invention has been described with respect to certain exemplary embodiments thereof, it is evident that many alternatives, modifications and variations will be apparent to those skilled in the art. Accordingly, the exemplary embodiments of the invention set forth herein are intended to be illustrative and not limiting in any way. Various changes may be made without departing from the spirit and scope of the present invention as defined in the following claims.

What is claimed is:

1. A head-mountable loupe for observing an object, the loupe comprising:
a support configured to be attachable to the head of a user; and
optics mounted to the support and including an objective lens, left and right oculars and a plurality of beam folding mirrors;
wherein the loupe has an observation configuration in which:
the left and right oculars are disposed in front of left and right eyes, respectively, of the user, to establish a folded left beam path originating from the object, traversing the objective lens and the left ocular and reflected from plural beam folding mirrors, and to establish a folded right beam path originating from the object, traversing the objective lens and the right ocular and reflected from plural beam folding mirrors;
surface normals of first beam folding mirrors are oriented relative to a mathematical plane which coincides with optical axes of the left and right oculars under an angle within a range from 20° to 65°; and
portions of the left and right beam paths between the object and the first beam folding mirrors are each free of further beam folding mirrors.

2. The head-mountable loupe according to claim 1 wherein the objective lens comprises at least one first objective lens element disposed in the portions of the left and right beam paths disposed between the object and the first beam folding mirrors.

3. The head-mountable loupe according to claim 2 wherein the at least one first objective lens element is a single lens element traversed by both the left and right beam paths.

4. The head-mountable loupe according to claim 2 wherein the objective lens comprises at least one second objective lens element disposed in the portions of the left and right beam paths between the first beam folding mirrors and the left and right oculars, respectively.

5. The head-mountable loupe according to claim 4 wherein the at least one second objective lens element is a single lens element traversed by both the left and right beam paths.

6. The head-mountable loupe according to claim 4 wherein in the observation configuration of the loupe the at least one second objective lens element has an optical axis oriented relative to a mathematical plane which coincides with optical axes of the left and right oculars under an angle (γ) of more than 70°.

7. The head-mountable loupe according to claim 1 wherein the angle of surface normals of the first beam folding mirrors relative to the mathematical plane coinciding with the optical axes of the left and right oculars in the observation configuration of the loupe is changeable by tilting the first beam folding mirrors.

8. The head-mountable loupe according to claim 1 further comprising second beam folding mirrors having surface normals oriented relative to the surface normals of the first beam folding mirrors under angles within a range from 60° to 110°.

9. The head-mountable loupe according to claim 8 wherein portions of the left and right beam paths between the first and second beam folding mirrors are each free of further beam folding mirrors, and wherein the objective lens comprises at least one objective lens element disposed in the portions of the left and right beam paths between the first and second beam folding mirrors.

10. The head-mountable loupe according to claim 1 further comprising a chassis mounted to the support for holding the optics;
wherein the loupe has a direct-view configuration in which the oculars are not disposed in front of the left and right eyes, respectively, of the user;
wherein the chassis comprises a main body and left and right chassis portions articulated to the main body;
wherein the left and right oculars are mounted to the left and right chassis portions, respectively;
wherein the left and right chassis portions are pivotable about left and right pivoting axes, wherein a distance between the left and right pivoting axes is within a range from 35 mm to 75 mm, and wherein distances between the left pivoting axis and the an optical axis of the left ocular and between the right pivoting axis and the an optical axis of the right ocular are greater than 20 mm.

11. A head-mountable loupe for observing an object, the loupe comprising:
a support configured to be attachable to the head of a user; and
optics mounted to the support and including an objective lens, left and right oculars and a plurality of beam folding mirrors;
wherein the loupe has an observation configuration in which:
the left and right oculars are disposed in front of left and right eyes, respectively, of the user, to establish a folded left beam path originating from the object, traversing the objective lens and the left ocular and reflected from plural beam folding mirrors, and to establish a folded right beam path originating from the object, traversing the objective lens and the right ocular and reflected from plural beam folding mirrors; and
the objective lens comprises at least one first objective lens element having an optical axis oriented relative to a mathematical plane which coincides with optical axes of the left and right oculars under an angle (γ) of more than 70°.

12. The head-mountable loupe according to claim 11 wherein the at least one first objective lens element is a single lens element traversed by both the left and right beam paths.

13. The head-mountable loupe according to claim 11 wherein the at least one first objective lens element is a single lens element traversed by both t wherein in the observation configuration of the loupe surface normals of first beam folding mirrors are oriented relative to a mathematical plane which coincides with optical axes of the left and right oculars under an angle within a range from 20° to 65°; and portions of the left and right beam paths between the object and the first beam folding mirrors are each free of further beam folding mirrors.

14. The head-mountable loupe according to claim 13 wherein the angle of surface normals of the first beam folding mirrors relative to the mathematical plane coinciding with the optical axes of the left and right oculars in the observation configuration of the loupe is changeable by tilting the first beam folding mirrors.

15. The head-mountable loupe according to claim 13 wherein the at least one first beam folding mirrors are provided by a common mirror having a contiguous mirror surface.

16. The head-mountable loupe according to claim 13 wherein the at least one first beam folding mirrors are provided by a common mirror having a further comprising second beam folding mirrors having surface normals oriented relative to the surface normals of the first beam folding mirrors under angles within a range from 60° to 110°.

17. The head-mountable loupe according to claim 16 wherein the second beam folding mirrors are provided by a common mirror having a contiguous mirror surface.

18. The head-mountable loupe according to claim 16 wherein portions of the left and right beam paths between the first and second beam folding mirrors are each free of further beam folding mirrors, and wherein the objective lens comprises at least one objective lens element disposed in the portions of the left and right beam paths between the first and second beam folding mirrors.

19. The head-mountable loupe according to claim 11 further comprising a chassis mounted to the support for holding the optics;
wherein the loupe has a direct-view configuration in which the oculars are not disposed in front of the left and right eyes, respectively, of the user;
wherein the chassis comprises a main body and left and right chassis portions articulated to the main body;
wherein the left and right oculars are mounted to the left and right chassis portions, respectively;
wherein the left and right chassis portions are pivotable about left and right pivoting axes, wherein a distance between the left and right pivoting axes is within a range from 35 mm to 75 mm, and wherein distances between the left pivoting axis and the an optical axis of the left ocular and between the right pivoting axis and the an optical axis of the right ocular are greater than 20 mm.

20. The head-mountable loupe according to claim 11 wherein the first objective lens element is a first removable objective lens element mounted on a frame structure comprising a handle portion exposed at a loupe body and allowing the user to grasp the frame structure to remove it from the loupe.

21. A head-mountable loupe for observing an object, the loupe comprising:
a support configured to be attachable to the head of a user; and
a chassis mounted to the support for holding optics, the optics including an objective lens, left and right oculars and a plurality of beam folding mirrors;
wherein the loupe has an observation configuration in which the left and right oculars are disposed in front of left and right eyes, respectively, of the user, to establish a folded left beam path originating from the object, traversing the objective lens and the left ocular and reflected from plural beam folding mirrors, and to establish a folded right beam path originating from the object, traversing the objective lens and the right ocular and reflected from plural beam folding mirrors;
wherein the loupe has a direct-view configuration in which the oculars are not disposed in front of the left and right eyes, respectively, of the user;
wherein the chassis comprises a main body and left and right chassis portions articulated to the main body;
wherein the left and right oculars are mounted to the left and right chassis portions, respectively;
wherein the left and right chassis portions are pivotable about left and right pivoting axes, wherein a distance between the left and right pivoting axes is within a range from 35 mm to 75 mm, and wherein distances between the left pivoting axis and the an optical axis of the left ocular and between the right pivoting axis and the an optical axis of the right ocular are greater than 20 mm.

22. The head-mountable loupe according to claim 21 further comprising at least one movable lens disposed in the left beam path and displaceable in a direction thereof, and at least one movable lens disposed in the right beam path and displaceable in a direction thereof, for changing a magnification of the loupe.

23. The head-mountable loupe according to claim 21 wherein the objective lens comprises at least one first objective lens element and at least one second objective lens element displaceable relative to the at least one first objective lens element for changing focal length of the loupe to account for a change of distance of an object plane of the loupe from the left and right oculars.

24. The head-mountable loupe according to claim 21 wherein the objective lens comprises at least one first removable objective lens element mounted on a frame structure comprising a handle portion exposed at a loupe body and allowing the user to grasp the frame structure to remove it from the loupe.

25. The head-mountable loupe according to claim 21 wherein the support is a headband system.

26. The head-mountable loupe according to claim 21 wherein the support is an eyeglass frame.
